(19) United States
(12) Patent Application Publication
(10) Pub. No.: US 2026/0214083 A1
(43) Pub. Date: Jul. 23, 2026

(54) COMMUNICATION SYSTEM, SETTING METHOD AND PROGRAM

(71) Applicant: NTT, Inc., Tokyo (JP)

(72) Inventors: Manabu YOSHINO, Musashino-shi (JP); Kazutaka HARA, Musashino-shi (JP); Shin KANEKO, Musashino-shi (JP); Junichi KANI, Musashino-shi (JP)

(73) Assignee: NTT, Inc., Tokyo (JP)

(21) Appl. No.: 19/140,710

(22) PCT Filed: Dec. 26, 2022
(86) PCT No.: PCT/JP2022/047841

§ 371 Date: Jun. 18, 2025

(51) Int. Cl. H04L 9/40

(52) U.S. Cl. CPC H04L 63/08; H04L 63/02

(57) ABSTRACT

A communication system includes an authentication unit that authenticates setting change control for changing a setting related to a control device or a main signal transmission/reception unit, and performs the setting related to the main signal transmission/reception unit according to an authentication result.

### TECHNICAL FIELD

The present invention relates to a technology of a communication system, a setting method, and a program.

### BACKGROUND ART

As one of business telecommunication facilities installed in a user's house, there is a communication device (transceiver accommodation device) that accommodates a transceiver used for digital coherent communication. The transceiver accommodation device is, for example, a white box transponder including a white box switch (WBS) and a transponder. The transceiver accommodation device is also called open transponder (see, for example, Non Patent Literature 1). Specific examples of the white box switch include Galileo and Cassini.

The white box switch can construct an optical transmission system in combination with a large-capacity coherent optical transceiver by implementing device software (for example, Non Patent Literature 1 discloses goldstone) on hardware. Usually, software implementation and device control including a transceiver are performed by a local account from a management interface such as a serial port or an Ethernet (registered trademark) port on which the device is implemented.

### CITATION LIST

### Non Patent Literature

Non Patent Literature 1: Nishizawa et al, “Open whitebox architecture for smart integration of optical networking and data center technology”, Jocn-13-1-A78

### SUMMARY OF INVENTION

### Technical Problem

The transceiver accommodated in the transceiver accommodation device can be changed in setting by a user via the transceiver accommodation device. There is a possibility that an operation against an intention of a telecommunications carrier is executed by control of the transceiver accommodation device by the user who logs in through the management port of the transceiver accommodation device. The operation against the intention of the telecommunications carrier is, for example, a change and readout of a predetermined setting (related setting) that is not allowed to be changed in terms of service of the transceiver accommodation device or the accommodated transceiver installed in the user's house or the like, and rewrite (replacement and addition) of software that is not allowed to be changed in terms of service. However, conventionally, there has been a problem that it is not possible to suppress an influence of the operation against the intention of the telecommunications carrier.

In view of the above circumstances, an object of the present invention is to provide a technology capable of suppressing an influence of an operation against an intention of a telecommunications carrier regarding a business telecommunication facility installed in a user's house

### Solution to Problem

One aspect of the present invention is a communication system including an authentication unit that authenticates one of a control device arranged in a communication network or setting control for setting related to a main signal transmission/reception unit, and performs the setting related to a main signal transmission/reception unit according to an authentication result.

One aspect of the present invention is a setting method executed by a communication system, the setting method including an authentication step of authenticating one of a control device arranged in a communication network or setting control for setting related to a main signal transmission/reception unit, and performing the setting related to a main signal transmission/reception unit according to an authentication result.

One aspect of the present invention is a program for causing a computer to execute an authentication step of authenticating a control device arranged in a communication network or setting control for setting related to a main signal transmission/reception unit, and performing the setting related to a main signal transmission/reception unit according to an authentication result.

### Advantageous Effects of Invention

According to the present invention, it is possible to suppress an influence of an operation against the intention of the telecommunications carrier regarding a business telecommunication facility installed in the user's house.

### BRIEF DESCRIPTION OF DRAWINGS

FIG. 1 A diagram illustrating a configuration example of a communication system in a first embodiment.

FIG. 2 A flowchart illustrating a flow of processing (part 1) of a transceiver accommodation device in the first embodiment.

FIG. 3 A flowchart illustrating a flow of processing (part 2) of the transceiver accommodation device in the first embodiment.

FIG. 4 A diagram illustrating a configuration in which a main signal transmission/reception unit of the transceiver accommodation device includes an interruption unit and an authentication unit is included in a control device.

FIG. 5 A diagram illustrating a configuration example of a communication system in a second embodiment.

FIG. 6 A sequence diagram illustrating a flow of processing performed by the communication system according to the second embodiment.

FIG. 7 A diagram illustrating a configuration example of a communication system in a third embodiment.

FIG. 8 A flowchart illustrating a flow of processing of a transceiver accommodation device in the third embodiment.

FIG. 9 A diagram illustrating a configuration example of a communication system in a fourth embodiment.

FIG. 10 A diagram illustrating a configuration example of a communication system in a fifth embodiment.

FIG. 11 A diagram illustrating a configuration example of a communication system in a sixth embodiment.

FIG. 12 A diagram illustrating a configuration example of a communication system in a seventh embodiment.

FIG. 13 A diagram illustrating a configuration example of a communication system in an eighth embodiment.

FIG. 14 A diagram illustrating an example hardware configuration of the communication system in each embodiment.

### DESCRIPTION OF EMBODIMENTS

Hereinafter, embodiments of the present invention will be described with reference to the drawings.

### Overview

A communication system according to an embodiment authenticates any one of a control device or a functional unit arranged in a communication network or setting change control for setting related to a main signal transmission/reception unit, permits the setting related to the main signal transmission/reception unit in a case where control from the authenticated control device or functional unit, or authenticated setting change control has arrived, and does not permit the setting related to the main signal transmission/reception unit in a case where control from an unauthenticated device or functional unit, disconnection to the authenticated device or functional unit, or unauthenticated setting change control has arrived, thereby suppressing an influence of an operation against an intention of a telecommunications carrier related to a business telecommunication facility installed in a user's house.

### Control from Authenticated Control Device

Here, the control from the authenticated control device includes, for example, any control from the authenticated control device described below.
Main signal interruption release (main signal transmission)
Main signal interruption (transmission interruption of main signal)
Power feed stop of a functional unit or a device related to the main signal (power feed interruption) or power feed (power feed permission)
A setting value related to the main signal or quality of the main signal such as a wavelength (optical frequency), a wavelength width (frequency width), a polarization, a multivalued degree, or a transmission scheme of the main signal
Representing control related to setting and setting change of a setting value that affects the main signal itself to be controlled or other main signal that share the channel or the like with the main signal to be controlled or use an adjacent channel, or the quality of the another main signal, for example, the setting value related to the main signal or the quality of the main signal such as a wavelength (optical frequency), a wavelength width (frequency width), a polarization, a multivalued degree, or a transmission scheme of the main signal

The authenticated setting change control includes, for example, any one of the following authenticated controls, and control contents are, for example, those described in [Control from Authenticated Control Device] (for example, paragraph 0014).
Control of main signal interruption release (main signal transmission) encoded with a predetermined secret key held by an authenticated device or functional unit or a device or a functional unit that has performed authentication, and properly decoded with a predetermined secret key held by an opposing device or a functional unit
Control of main signal interruption (transmission interruption of main signal) encoded with a predetermined secret key held by an authenticated device or functional unit or a device or a functional unit that has performed authentication, and properly decoded with a predetermined secret key held by an opposing device or a functional unit
Control of power feed stop (power feed interruption) or power feed (power feed permission) of a functional unit or a device relating to a main signal encoded with a predetermined secret key held by an authenticated device or functional unit or a device or a functional unit that has performed authentication, and properly decoded with a predetermined secret key held by an opposing device or a functional unit
Control of the setting value related to the main signal or the quality of the main signal such as a wavelength (optical frequency), a wavelength width (frequency width), a polarization, a multivalued degree, or a transmission system of the main signal encoded with a predetermined secret key held by an authenticated device or functional unit or a device or a functional unit that has performed authentication, and properly decoded with a predetermined secret key held by an opposing device or functional unit
Control of setting or setting change of the setting value that affects the main signal to be controlled itself encoded with a predetermined secret key held by an authenticated device or functional unit or a device or a functional unit that has performed authentication, and properly decoded with a predetermined secret key held by an opposing device or functional unit, another main signal that that shares a channel or the like with the main signal or uses an adjacent channel, or the quality of the another main signal, for example, the setting value related to the main signal or the quality of the main signal such as a wavelength (optical frequency), a wavelength width (frequency width), a polarization, a multivalued degree, or a transmission system of the main signal
Control of main signal interruption release (main signal transmission) encoded with a predetermined secret key held by an authenticated device or functional unit or a device or a functional unit that has performed authentication, and properly decoded with a predetermined public key held by an opposing device or a functional unit
Control of main signal interruption (transmission interruption of main signal) encoded with a predetermined secret key held by an authenticated device or functional unit or a device or a functional unit that has performed authentication, and properly decoded with a predetermined public key held by an opposing device or a functional unit
Control of power feed stop (power feed interruption) or power feed (power feed permission) of a functional unit or a device relating to a main signal encoded with a predetermined secret key held by an authenticated device or functional unit or a device or a functional unit that has performed authentication, and properly decoded with a predetermined public key held by an opposing device or a functional unit
Control of the setting value related to the main signal or the quality of the main signal such as a wavelength (optical frequency), a wavelength width (frequency width), a polarization, a multivalued degree, or a transmission system of the main signal encoded with a predetermined secret key held by an authenticated device or functional unit or a device or a functional unit that has performed authentication, and properly decoded with a predetermined public key held by an opposing device or functional unit
Control of setting or setting change of the setting value that affects the main signal to be controlled itself encoded with a predetermined secret key held by an authenticated device or functional unit or a device or a functional unit that has performed authentication, and properly decoded with a predetermined public key held by an opposing device or functional unit, another main signal that that shares a channel or the like with the main signal or uses an adjacent channel, or the quality of the another main signal, for example, the setting value related to the main signal or the quality of the main signal such as a wavelength (optical frequency), a wavelength width (frequency width), a polarization, a multivalued degree, or a transmission system of the main signal

On the other hand, the unauthenticated setting change control includes control other than the above-described control, in particular, control that potentially affects a service itself provided to a user by a business operator who has installed electrical equipment or a service provided to users other than the user by the business operator or a business operator who shares a medium, or the like. Examples of such control include setting change control transmitted from a user-side control terminal operated by a user in which the business telecommunication facility is installed, and control for changing a predetermined setting that is not allowed to be changed in terms of service of the transceiver.

Note that, in the communication system, in a case where connection with the authenticated control device is disconnected, in a case where there has been access from the unauthenticated device, in a case where the control device cannot be authenticated, or in a case where the unauthenticated setting change control has arrived, communication of a control signal between the main signal transmission/reception unit and the control device in the communication network may not be accepted or may be interrupted, or communication of the main signal between the main signal transmission/reception unit and (the opposing device related to the main signal via) the communication network may be interrupted. Hereinafter, specific configurations for implementing the above processing will be described.

Note that, in the communication system, in the case where connection with the authenticated control device is disconnected, in the case where there has been access from the unauthenticated device, in the case where the control device cannot be authenticated, or in the case where the unauthenticated setting change control has arrived, the authentication of the authenticated control device may be canceled or re-authenticated, exchange of the control signal between the main signal transmission/reception unit and the control device in the communication network may be interrupted, or the communication of the main signal between the main signal transmission/reception unit and (the opposing device related to the main signal via) the communication network may be interrupted. Hereinafter, specific configurations for implementing the above processing will be described.

### First Embodiment

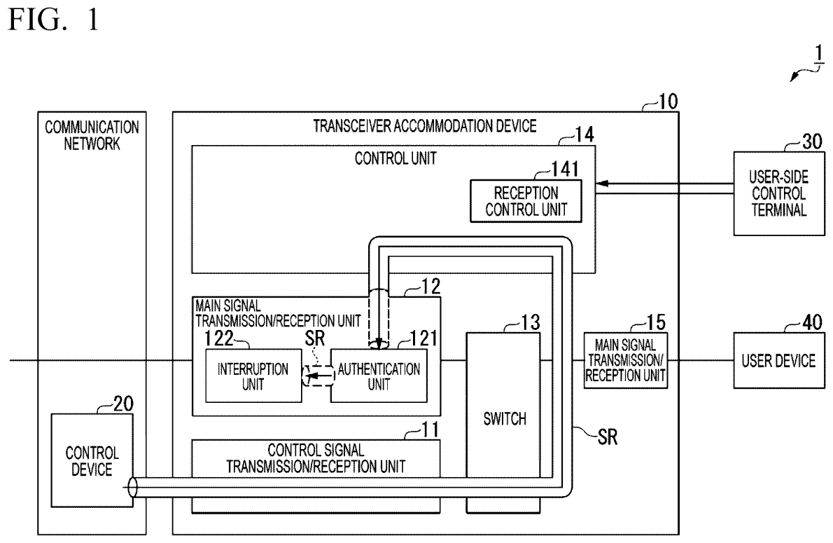

FIG. 1 is a diagram illustrating a configuration example of a communication system 1a according to a first embodiment. The communication system 1a includes a transceiver accommodation device 10 and a control device 20. The communication system 1a is, for example, an optical transmission system in an all-photonics network (APN). A user device 40 is connected to the transceiver accommodation device 10. Note that there is a possibility that a user-side control terminal 30 is connected to the transceiver accommodation device 10 via a management port such as a serial bus. Note that the possibility of connection is not limited to the serial bus.

The transceiver accommodation device 10 is provided in a user's house. The transceiver accommodation device 10 includes, for example, a white box switch in which software is installed, a transceiver for transmitting and receiving a main signal, and a transceiver for transmitting and receiving a control signal. The transceiver accommodation device 10 includes a control signal transmission/reception unit 11, a main signal transmission/reception unit 12, a switch 13, a control unit 14, and a main signal transmission/reception unit 15. The main signal transmission/reception unit 12 includes an authentication unit 121 and an interruption unit 122. The control unit 14 includes a reception control unit 141.

The control signal transmission/reception unit 11 is an example of a transceiver for transmitting and receiving the control signal, and the main signal transmission/reception unit 12 is an example of a transceiver for transmitting and receiving the main signal. In FIG. 1, the control signal transmission/reception unit 11 and the main signal transmission/reception unit 12 are illustrated separately, but may be integrated. In this case, the main signal and the control signal may be demultiplexed by wavelength division multiplexing, frequency division multiplexing such as auxiliary management and control channel (AMCC), polarization multiplexing, time division multiplexing, or the like.

When the authentication unit 121 is in the main signal transmission/reception unit 12 (transceiver) of the transceiver accommodation device 10, interaction of control between the authentication unit 121 and the main signal transmission/reception unit 12 is internal processing. Therefore, the interaction (control) is easily concealed and hardly cracked. In a case where the main signal output from the main signal transmission/reception unit 12 in an inappropriate case is interrupted by the processing from the authentication unit 121, the interruption or the like is also accelerated. However, in a case where the authentication unit 121 is provided in the main signal transmission/reception unit 12 of the transceiver accommodation device 10, the function is arranged on the main signal transmission/reception unit 12. Therefore, processing that requires many resources is limited from the viewpoint of an amount of power and a volume possible for the main signal transmission/reception unit 12, and it is necessary to create the main signal transmission/reception unit 12 having such a function. In addition, in a case where the interruption unit 122 interrupts the main signal itself output from the main signal transmission/reception unit 12 itself in the transceiver accommodation device 10 instead of in the main signal transmission/reception unit 12, and in a case where the interruption unit 122 interrupts the main signal itself output from the main signal transmission/reception unit 12 itself on a communication network side instead of in the main signal transmission/reception unit 12, the authentication unit 121 controls (interacts with) the transceiver accommodation device 10 or the communication network side and performs interruption, and is thus slow.

In the case where the authentication unit 121 is in the transceiver accommodation device 10, resources such as a central processing unit (CPU) and a memory of the transceiver accommodation device 10 can be used. Therefore, processing such as authentication requiring the resources can be performed as compared with the case where the authentication unit 121 is arranged in the main signal transmission/reception unit 12. In this case, since there is a possibility that the interaction with the main signal transmission/reception unit 12 is hindered or cracked, it is desirable that the transceiver accommodation device 10 also perform an operation for interruption. In a case where the main signal transmission/reception unit 12 receives some control, if the control is performed after the authentication unit 121 on the transceiver accommodation device 10 is checked whether the control is proper, or if the main signal transmission/reception unit 12 that communicates only with special software or hardware mounted in the transceiver accommodation device 10 is used, a special transceiver that is weaker than the authentication unit 121 is arranged on the main signal transmission/reception unit 12 but the special transceiver having such functions is required.

On the contrary, in a case where the special transceiver is not used, a known general interface is used, and is thus more susceptible to cracking than the special interface. Therefore, an unauthenticated setting change is monitored, and when there is an unauthenticated setting change, the changed setting may be rewritten, main signal transmission itself may be interrupted, or the setting may be written back to the authenticated setting. To interrupt the main signal transmission itself, power feed of the main signal transmission/reception unit 12 may be stopped, or the power feed of the entire transceiver accommodation device 10 may be stopped. Alternatively, the settings may be continuously changed to authenticated settings or the like without monitoring the settings or the like.

Although the interruption of the main signal itself is slower than the case where the functions for interruption are arranged on the main signal transmission/reception unit 12, the interruption becomes possible by the control of the transceiver accommodation device 10 by stopping the power feed to the main signal transmission/reception unit 12, stopping transfer of data itself transmitted/received as the main signal via the main signal transmission/reception unit 12 by a switch that connects the main signal transmission/reception unit 12 and a user network interface (UNI), restarting the transceiver accommodation device 10, or turning off a power supply of the transceiver accommodation device 10. In addition, in a case where the interruption unit 122 interrupts the main signal itself output from the main signal transmission/reception unit 12 itself in the main signal transmission/reception unit 12 instead of in the transceiver accommodation device 10, and in a case where the interruption unit 122 interrupts the main signal on the communication network side instead of in the transceiver accommodation device 10, the authentication unit 121 controls (interacts with) the main signal transmission/reception unit 12 or the communication network side and performs interruption, and is thus slow.

If the authentication unit 121 is in the transceiver accommodation device 10, particularly in the main signal transmission/reception unit 12, monitoring is quicker than that if the authentication unit 121 is in the control device 20 on the communication network side, and authentication can be performed even if the control signal is stopped. Here, the “monitoring is quicker” means that a setting value held by the main signal transmission/reception unit 12 or the setting itself is monitored quicker.

When the interruption unit 122 and the authentication unit 121 are in the transceiver accommodation device 10, particularly in the main signal transmission/reception unit 12, interruption in a case where an abnormality in authentication or setting is detected or in a case where the detected abnormality cannot be corrected is quick. In the case where the interruption unit 122 and the authentication unit 121 are included in the main signal transmission/reception unit 12, detection and interruption of abnormality or uncorrectable abnormality (within a predetermined time) are closed in the main signal transmission/reception unit 12. Therefore, in a case of interrupting the main signal transmission of the main signal transmission/reception unit 12, it is possible to quickly interrupt the main signal transmission. Note that, in a case where the interruption of the interruption unit 122 is performed by controlling the transceiver accommodation device 10 or the communication network side, the interruption is difficult in a case where a control route from the main signal transmission/reception unit 12 to the transceiver accommodation device 10 or to the communication network side is disconnected. Therefore, it is desirable to perform the interruption in the main signal transmission/reception unit 12. The above-described predetermined time is, for example, a time for permitting transmission of an inappropriate signal, a time obtained by subtracting a time required for control from the time, or a predetermined time.

When the interruption unit 122 and the authentication unit 121 are in the transceiver accommodation device 10, particularly in the main signal transmission/reception unit 12, and receive a response of authentication completion, interruption in a case where an abnormality in authentication or setting is detected or in a case where the detected abnormality cannot be corrected is quick.

In the case where the interruption unit 122 and the authentication unit 121 are included in the transceiver accommodation device 10, particularly in the main signal transmission/reception unit 12, detection of abnormality, detection of uncorrectable abnormality (within a predetermined time), or detection and interruption of reception of response of authentication completion within a predetermined time are closed in the transceiver. Therefore, in a case of interrupting the main signal transmission of the main signal transmission/reception unit 12, it is possible to quickly interrupt the main signal transmission. Note that, in a case where the interruption of the interruption unit 122 is performed by controlling the transceiver accommodation device 10 or the communication network side, the interruption is difficult in a case where a control route from the main signal transmission/reception unit 12 to the transceiver accommodation device 10 or to the communication network side is disconnected. Therefore, it is desirable to perform the interruption in the main signal transmission/reception unit 12.

The white box switch includes, as hardware, the control unit 14 of the white box switch such as a CPU, a control interface to the control unit 14, and the switch 13. The transceiver accommodation device 10 in the present embodiment is configured by combining the control signal transmission/reception unit 11, the main signal transmission/reception unit 12, and the main signal transmission/reception unit 15 in the white box switch. Software executed on the control unit 14 includes, for example, a set of software such as a network operating system (NOS) of a normal white box switch and a goldstone, a setting function, an interruption function, and the like to be described below.

The control device 20 is arranged in a communication network. The control device 20 is, for example, a photonic gateway or a controller of a photonic gateway. The control device 20 controls predetermined settings (related settings) (for example, setting of a wavelength of an optical signal of the main signal) that are not allowed to be changed in terms of service of the main signal transmission/reception unit 12 included in the transceiver accommodation device 10. For example, the control device 20 controls the settings and the like of the main signal transmission/reception unit 12 by transmitting the control signal to the transceiver accommodation device 10. Furthermore, the control device 20 may confirm the controlled settings or the like by receiving a response. Examples of control content such as the setting of the main signal transmission/reception unit 12 include any of activation, stop, or restart of the main signal transmission/reception unit 12, setting of a predetermined parameter, transmission start or stop of the main signal, parameter setting change, parameter setting deletion, and interruption (any one of transmission stop, output intensity reduction, stop, restart, or power disconnection of the main signal transmission/reception unit 12, power disconnection of the transceiver accommodation device 10, or disconnection on the communication network side).

The user-side control terminal 30 is a device operated by a user at user's house where the transceiver accommodation device 10 is installed. The user-side control terminal 30 can access the transceiver accommodation device 10 to change the settings of the main signal transmission/reception unit 12 included in the transceiver accommodation device 10. Operations of the user operating the user-side control terminal 30 to change the settings of the main signal transmission/reception unit 12 include operations against an intention of a telecommunications carrier (for example, change and reading of related settings of the main signal transmission/reception unit 12 (transceiver) and rewriting (replacement and addition) of related software). The user-side control terminal 30 is configured using an information processing device such as a personal computer.

The user device 40 transmits and receives the main signal to and from an opposing device via the transceiver accommodation device 10 and the communication network. The user device 40 is customer premises equipment (CPE). The user device 40 is connected to a transceiver or a network interface card (NIC) that transmits and receives the main signal on the user side included in the transceiver accommodation device 10. For example, the user device 40 is connected to the main signal transmission/reception unit 15 that communicates (transmits/receives) the main signal with the user side in the transceiver accommodation device 10.

Next, a specific configuration of the transceiver accommodation device 10 will be described.

The control signal transmission/reception unit 11 is a transceiver for the control signal. The control signal transmission/reception unit 11 transmits and receives the control signal to and from the control device 20 in the communication network. Note that the control signal transmitted and received between the control signal transmission/reception unit 11 and the control device 20 in the communication network may be an electrical signal or an optical signal. In a case where the control signal is wavelength-division-multiplexed with the main signal, the control signal is an optical signal. The control signal transmission/reception unit 11 may use another communication network (not illustrated) instead of the communication network. The control signal transmission/reception unit 11 may be connected from a management port of the transceiver accommodation device 10 directly from another communication network (not illustrated) or via a dongle or the like connected thereto.

The control signal transmitted from the control device 20 includes information instructing a predetermined parameter of the main signal transmission/reception unit 12 of the transceiver accommodation device 10. Examples of the predetermined parameter of the main signal transmission/reception unit 12 include light emission or extinction (for example, tx-dis false/true), light intensity, a wavelength (wavelength grid (for example, 100-ghz|50-ghz|33-ghz|25-ghz|12-5-ghz|6-25-ghz, or the like), an optical frequency, a channel number), or the like. The predetermined parameter of the main signal transmission/reception unit 12 may include information such as a transmission format (for example, bpsk|dp-bpsk|qpsk|dp-qpsk|8-qam|dp-8-qam|16-qam|dp-16-qam|32-qam|dp-32-qam|64-qam|dp-64-qam, or the like), a line rate (for example, 100 g|200 g|300 g|400 g, or the like), or a forward error correction (FEC) type (for example, sc(Staircase)-fec|c(Concatenated)fec|o(Open)fec, or the like).

The control signal transmission/reception unit 11 outputs the received control signal to the switch 13. Note that, in the case where the control signal is an optical signal, the control signal transmission/reception unit 11 converts the received control signal into an electrical signal and outputs the electrical signal to the switch 13. In the drawing, the control signal transmission/reception unit 11 is configured to exchange signals, for example, optical signals with the control device 20 in the communication network and is connected to the reception control unit 141 via the switch 13. However, in a case where there is a serial, a universal serial bus (USB), or an Ethernet interface in the management port of the transceiver accommodation device 10, a transceiver or a dongle connected to the serial, the USB, or the Ethernet interface and capable of communicating with the control device 20 on the communication network side may be adopted, and the transceiver or the dongle may be replaceable.

The main signal transmission/reception unit 12 is a transceiver for the main signal. The main signal transmission/reception unit 12 transmits and receives the main signal such as an optical signal to and from the opposing device via the communication network. The main signal transmission/reception unit 12 converts the received main signal into an electrical signal and outputs the electrical signal to the switch 13. The main signal transmission/reception unit 12 is usually a replaceable transceiver.

In a case where the main signal transmission/reception unit 12 is an analogue coherent optics (ACO) transceiver, a digital signal processing unit (not illustrated) is provided between the main signal transmission/reception unit 12 and the switch 13. The digital signal processing unit performs signal processing such as optical transport network (OTN) framing, FEC, modulation/demodulation processing, and optical degradation correction for the electrical signal output from the main signal transmission/reception unit 12.

In the case where the main signal transmission/reception unit 12 is a digital coherent optics (DCO) transceiver, the main signal transmission/reception unit 12 incorporates a digital signal processing unit. The digital signal processing unit of the main signal transmission/reception unit 12 performs OTN framing, FEC, modulation/demodulation processing, optical degradation correction, and the like.

In the following description, it is assumed that the signal of the control signal transmission/reception unit 11 and the signal of the main signal transmission/reception unit 12 are multiplexed by wavelength division multiplexing or the like and transmitted through the same optical fiber (for example, an optical fiber or a transmission path).

The main signal transmission/reception unit 15 transmits and receives the main signal to and from the user device 40. The main signal transmission/reception unit 15 is a transceiver or an NIC.

The switch 13 connects the main signal transmission/reception unit 12 and the main signal transmission/reception unit 15, and connects the control signal transmission/reception unit 11 and the control unit 14. In addition, the switch 13 connects the main signal transmission/reception unit 12 and the control unit 14 in a case where the main signal or a frame or AMCC for transmitting the main signal communicates the control signal. For example, the switch 13 connects the main signal transmission/reception unit 12 and the main signal transmission/reception unit 15 to transmit the main signal. For example, the switch 13 transfers the control signal transmitted from the control device 20 to the control unit 14 by connecting the control signal transmission/reception unit 11 and the control unit 14. In this manner, the switch 13 also functions as an adapter for passing the control signal transmitted from the control device 20 to the control unit 14.

The control unit 14 performs control related to at least the main signal transmission/reception unit 12. The control unit 14 includes one or more processors such as a CPU and one or more memories. The control unit 14 implements the functions of the reception control unit 141 by the one or more processors executing the program. Some or all of the functions of the control unit 14 may be implemented using hardware such as an application specific integrated circuit (ASIC), a programmable logic device (PLD), or a field programmable gate array (FPGA). The above program may be recorded in a computer-readable recording medium. The computer-readable recording medium is, for example, a portable medium such as a flexible disk, a magneto-optical disk, a read only memory (ROM), a compact disc read only memory (CD-ROM), or a semiconductor storage device (for example, a solid state drive (SSD)), or a storage device such as a hard disk or a semiconductor storage device built in a computer system. The above program may be transmitted via a telecommunication line.

The reception control unit 141 desirably constructs a control signal route SR between the reception control unit 141 and the control device 20 via the control signal transmission/reception unit 11 and the switch 13, the control signal route SR enabling access to at least the related settings for which a change in settings related to the main signal transmission/reception unit 12 should be restricted, before communication transmission between the transceiver accommodation device 10 and the opposing device is permitted. For example, the reception control unit 141 constructs the control signal route SR between the control device 20 and the authentication unit 121 in the main signal transmission/reception unit 12, and between the authentication unit 121 in the main signal transmission/reception unit 12 and the interruption unit 122. Note that, in a case where the inside of the main signal transmission/reception unit 12 is in a secure environment, the reception control unit 141 may construct the control signal route SR between the control device 20 and the main signal transmission/reception unit 12, and may not construct the control signal route SR in a route indicated by the broken line in the main signal transmission/reception unit 12 illustrated in FIG. 1 (a route from the main signal transmission/reception unit 12 to the authentication unit 121 in the main signal transmission/reception unit 12) and a route indicated by the broken line between the authentication unit 121 and the interruption unit 122 in the main signal transmission/reception unit 12 illustrated in FIG. 1. Here, the secure environment inside the main signal transmission/reception unit 12 is an environment in which at least exchange of information performed inside the main signal transmission/reception unit 12 is not intercepted or data is not falsified.

Moreover, it is more desirable not only to construct the control signal route SR but also to permit predetermined settings after the control unit 14 is set to receive only control from the reception control unit 141. This is because there is a possibility that an unintended main signal is transmitted if any of them is not completed and permitted. In this manner, the control unit 14 permits the communication transmission of the main signal after login is restricted. However, the present embodiment is not limited thereto in a case where the interruption is performed in advance by the interruption unit to be described below. The control signal route SR enables change of the settings related to the main signal transmission/reception unit 12 or access to predetermined related settings whose readout should be restricted.

Here, the control signal route SR is desirably a highly secure communication route such as a virtual private network (VPN). However, the control signal route SR is a control signal route that enables access to the related settings, and is not necessarily required to be a highly secure communication route as long as an unauthenticated device (for example, the user-side control terminal 30) cannot access the functional units (for example, the reception control unit 141, the authentication unit 121, and the interruption unit 122) included in the transceiver accommodation device 10. By using such a control signal route SR, it is possible to prevent interception or falsification of exchange between the functional units by a malicious user. Moreover, the reception control unit 141 notifies or responds to the control device 20 of a setting state (setting execution completion or setting value). Here, a secure communication route is desirably a route from the control device 20 to the authentication unit 121, particularly a case where the authentication unit 121 is included in the main signal transmission/reception unit 12.

The reception control unit 141 may communicate the related setting with the main signal transmission/reception unit 12 using a predetermined client signal, a generic communications channel (GCC) for control signals, AMCC, or the like. In this case, the reception control unit 141 may construct the control signal route SR between the main signal transmission/reception unit 12 and the control device 20. In the case where the control signal route SR is constructed between the main signal transmission/reception unit 12 and the control device 20, the reception control unit 141 constructs the control signal route SR after communication transmission between the transceiver accommodation device 10 and the opposing device (not illustrated) is permitted. Note that, for example, in a case where the control signal is not time-divisionally multiplexed in a format in which the control signal is frame-multiplexed into a user signal or in a format such as a frame (for example, GCC) that carries the user signal, the user signal may be discarded by the switch 13 or a predetermined functional unit other than the switch 13.

The authentication unit 121 authenticates either the control device 20 or setting change control. In a case where the control device 20 has been authenticated by the authentication unit 121, the transceiver accommodation device 10 accepts target settings (for example, the related settings) and control related to transmission from the control device 20. Accepting control means following an instruction of the control (for example, permitting transmission of the main signal in the case of transmission control of the main signal, setting an instructed value in the case of the setting control for a value of the related settings). On the other hand, in a case where the control device 20 has not been authenticated by the authentication unit 121, the transceiver accommodation device 10 does not accept the target settings (for example, the related settings) and the control related to transmission from the control device 20 that has not been authenticated. Not accepting the control means not following the instruction of the control. Note that, in the case where the control device 20 has not been authenticated by the authentication unit 121, the transceiver accommodation device 10 does not accept the control related to the settings (for example, the related settings) and the transmission, and may determine that cracking has occurred with a predetermined number of trials and perform interruption. For example, the authentication unit 121 confirms a control source each time of control, or confirms that the control source is authenticated by a route that transmits only the control signal from the authenticated control device 20.

The transceiver accommodation device 10 accepts control in a case where the control authenticated by the authentication unit 121 is the target settings, setting change, or transmission. On the other hand, the transceiver accommodation device 10 does not accept the control that has not been authenticated by the authentication unit 121.

The setting change control is performed by, for example, the control device 20 or a device other than the control device 20 (for example, the user-side control terminal 30). The authentication unit 121 permits only the authenticated setting change control among the setting change control that has arrived at the transceiver accommodation device 10. Permitting the setting change control means changing the settings related to the main signal transmission/reception unit 12. The authentication unit 121 does not permit the setting change control that has not been authenticated among the setting change control that has arrived at the transceiver accommodation device 10. Not permitting the setting change control means not changing the settings related to the main signal transmission/reception unit 12. Note that, in a case where the setting change control cannot be authenticated as normal, the authentication unit 121 may take a measure to interrupt the communication of the main signal in addition to not permitting the setting change control.

For example, in a case where a transmission source of the setting change control that has arrived at the transceiver accommodation device 10 is the control device 20, the authentication unit 121 may permit authentication of the setting change control transmitted from the control device 20. More desirably, the authentication unit 121 may permit the authentication of the setting change control transmitted from the control device 20 in a case where the transmission source of the setting change control is authenticated and the setting change control that has arrived at the transceiver accommodation device 10 is authenticated.

For example, in a case where the transmission source of the setting change control that has arrived at the transceiver accommodation device 10 is the user-side control terminal 30 and the instruction to change the related settings is given, the authentication unit 121 may not permit the authentication of the setting change control transmitted from the user-side control terminal 30. In a case of performing the setting change control, the control device 20 transmits, to the transceiver accommodation device 10, information related to a setting to be changed (for example, a target setting for setting change a setting value thereof) among the settings related to the main signal transmission/reception unit 12. In the authentication, a serial number may be used as an authentication key in a certain manner, such as MAC address authentication. In this case, a less easily falsified configuration such as a configuration to limit the authentication to readout from an appropriate register is desirable. In addition, a protocol of IEEE802.1x may be used for authentication, a RADIUS server or the like may be used for authentication, and an ID/Password, a certificate, or a SIM card may be used as an authentication key. In this case, an authentication key may be inserted into the main signal transmission/reception unit 12 and distributed.

The interruption unit 122 permits transmission of the main signal in a case where an interruption release condition is satisfied, and interrupts the transmission of the main signal in a case where the interruption release condition is no longer satisfied. The interruption release condition is a condition for permitting the transmission between the main signal transmission/reception unit 12 and the control device 20 in the communication network. Normally, the transmission between the main signal transmission/reception unit 12 and the control device 20 in the communication network is not permitted and is in an interrupted state. Therefore, the interruption unit 122 permits the transmission of the main signal in the case where the interruption release condition is satisfied.

The interruption release condition is, for example, that one of the following conditions is satisfied. Examples of the interruption release condition include a case where there is an access from the control device 20 authenticated by the authentication unit 121, a case where the transmission is controlled from the control device 20 authenticated by the authentication unit 121, a case of being connected to the control device 20 authenticated by the authentication unit 121, and a case where the setting change control authenticated by the authentication unit 121 has arrived. On the other hand, in a case where the connection to the control device 20 authenticated by the authentication unit 121 is disconnected, in a case where the control device 20 has not been authenticated, in a case where there is an access from the control device 20 not authenticated by the authentication unit 121, or in a case where the setting change control not authenticated by the authentication unit 121 has arrived, the interruption release condition is not satisfied.

In view of the above points, the interruption unit 122 determines that the interruption release condition is satisfied in the case where there is an access from the control device 20 authenticated by the authentication unit 121, in the case where the control device 20 is authenticated by the authentication unit 121, in the case of being connected to the control device 20 authenticated by the authentication unit 121, or in the case where the setting change control authenticated by the authentication unit 121 has arrived. In the case where the interruption release condition is satisfied, the interruption unit 122 permits the transmission between the main signal transmission/reception unit 12 and the control device 20 in the communication network. That is, the interruption unit 122 releases the interruption of the transmission between the main signal transmission/reception unit 12 and the control device 20 in the communication network in the case where the interruption release condition is satisfied.

On the other hand, the interruption unit 122 determines that the interruption release condition is not satisfied in the case where the connection to the control device 20 authenticated by the authentication unit 121 has been disconnected, in the case where the control device 20 has not been authenticated, in the case where there has been an access from the control device 20 not authenticated by the authentication unit 121, or in the case where the setting change control not authenticated by the authentication unit 121 has arrived. In this case, the interruption unit 122 interrupts the transmission or continues the interrupted state between the main signal transmission/reception unit 12 and the control device 20 in the communication network. Note that the interruption unit 122 may perform the interruption when the control device 20 on the communication network side cannot normally interact with the transceiver accommodation device 10 or when abnormal traffic flows into the communication network.

The abnormal traffic is traffic that does not meet a value of a predetermined related setting. For example, the abnormal traffic is an inappropriate wavelength signal in the case where the value of the related setting is a wavelength, or is a signal having an inappropriate high intensity or low intensity in the case where the value of the related setting is an intensity. Moreover, the interruption unit 122 may have a function to hold setting information obtained by receiving the control signal including a setting instruction transmitted from the control device 20 or performing snooping, and may perform the interruption when setting, setting confirmation, or the like cannot be performed for the held setting information, when a setting abnormality is notified or detected, when a setting is rewritten from a route other than the route of the communication network (for example, a route other than the control signal route SR), or when a phenomenon to be rewritten has occurred.

When detecting a change in a setting other than a preset setting in the related settings, the interruption unit 122 may write back the setting to the preset setting instead of interruption, or may perform interruption in a case where the setting when the preset setting cannot be set.

Here, examples of a method of interrupting the transmission of the transceiver accommodation device 10 include at least one of the following methods: dropping an optical output of the main signal transmission/reception unit 12 to a negligible level (writing of a register or the like), turning off optical transmission (inputting to a hard pin or writing to a corresponding register or the like), stopping the main signal transmission/reception unit 12, restarting the main signal transmission/reception unit 12, turning off the power supply of the main signal transmission/reception unit 12, turning off the power feed of the main signal transmission/reception unit 12, turning off the power supply of the transceiver accommodation device 10a, interrupting the signal on the network side, and the like.

The main signal transmission/reception unit 12 implements the functions of the authentication unit 121 and the interruption unit 122 by the one or more processors executing the program. Note that the functions of the authentication unit 121 and the interruption unit 122 may be implemented by only hardware or may be implemented by a combination of hardware and a processor. In the case where the functions of the authentication unit 121 and the interruption unit 122 are implemented by a combination of hardware and a processor, only the determination of interruption release may be implemented by the processor, and the other functions may be implemented by the hardware.

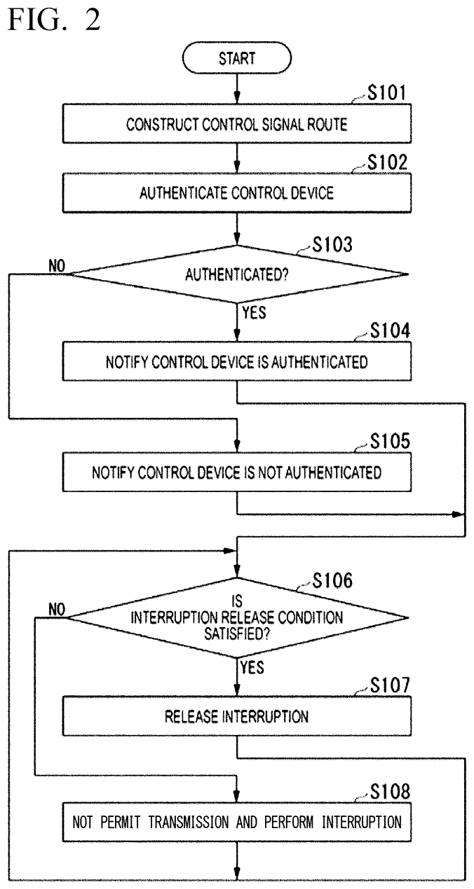

FIG. 2 is a flowchart illustrating a flow of processing (part 1) of the transceiver accommodation device 10 in the first embodiment. Note that, in FIG. 2, processing of a configuration in which the authentication unit 121 authenticates the control device 20 will be described.

The reception control unit 141 constructs the control signal route SR between the control device 20 and the transceiver accommodation device 10 before the communication transmission between the transceiver accommodation device 10 and the opposing device is permitted (step S101). Specifically, as illustrated in FIG. 1, the reception control unit 141 constructs the control signal route SR between the control device 20 and the authentication unit 121 in the main signal transmission/reception unit 12. As a result, it is possible to perform setting even if there is interference, and further, if the user cannot use the control signal route SR and it is difficult to set the related settings from a route other than the control signal route SR, it is possible to prevent malicious control from the user.

The control signal transmission/reception unit 11 receives the control signal transmitted from the control device 20 via the control signal route SR. The control signal transmission/reception unit 11 outputs the received control signal to the switch 13. The switch 13 transfers the received control signal to the control unit 14 by connecting the control signal transmission/reception unit 11 and the control unit 14. The control signal output from the switch 13 is input to the authentication unit 121 in the main signal transmission/reception unit 12 via the control signal route SR.

The authentication unit 121 authenticates the control device 20 on the basis of the input control signal (step S102). Specifically, the authentication unit 121 authenticates the control device 20 by exchanging the control signals with the control device 20. At this time, the authentication unit 121 exchanges the control signal with the control device 20 via the control signal route SR. As a result of the authentication, the authentication unit 121 determines whether the control device 20 has been authenticated (step S103). That is, the authentication unit 121 determines whether the control device 20 is valid as a result of the authentication.

In the case where the authentication has been performed, the authentication unit 121 permits control from the authenticated control device 20. In this case, the authentication unit 121 notifies the interruption unit 122 that the access has been made from the authenticated control device 20 (step S104). On the other hand, in the case where the authentication has not been performed, the authentication unit 121 does not permit the control from the control device 20 that has not been authenticated. In this case, the authentication unit 121 notifies the interruption unit 122 that the access has been made from the control device 20 that has not been authenticated (step S105).

Thereafter, the interruption unit 122 determines whether the interruption release condition is satisfied on the basis of the notification (whether the control device 20 is the control device 20 that has been authenticated) from the authentication unit 121 (step S106). In the case of determining that the interruption release condition is satisfied (step S106: YES), the interruption unit 122 releases the interruption of the communication of the main signal. Note that, in a case where the transmission has been being unpermitted, the interruption unit 122 permits the transmission of the main signal (step S107). Thereafter, the processing returns to step S106.

On the other hand, in the case of determining that the interruption release condition is not satisfied (step S106: NO), the interruption unit 122 interrupts the communication of the main signal (step S108). Note that, in a case where the transmission has been being permitted, the interruption unit 122 does not permit the transmission of the main signal. Thereafter, the processing returns to step S106.

Note that, in a case where the authentication of the control device 20 is canceled during the communication between the transceiver accommodation device 10 and the control device 20, the interruption unit 122 may determine that the interruption release condition is not satisfied.

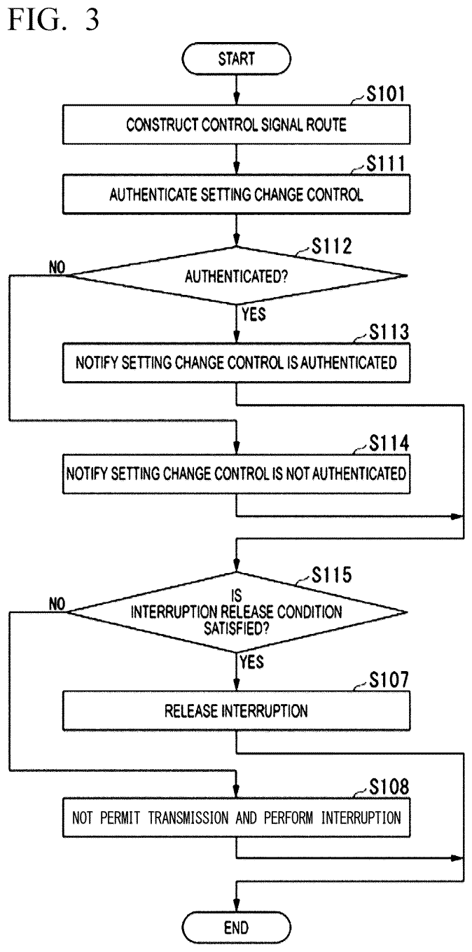

FIG. 3 is a flowchart illustrating a flow of processing (part 2) of the transceiver accommodation device 10 in the first embodiment. In FIG. 3, processing of a configuration in which the authentication unit 121 authenticates the setting change control that has arrived at the transceiver accommodation device 10 will be described. In FIG. 3, processing steps similar to those in FIG. 2 will be denoted by similar reference signs to those used in FIG. 2, and description thereof will be omitted.

After the processing of step S101, the authentication unit 121 authenticates the setting change control on the basis of the input control signal (step S111). As a result of the authentication, the authentication unit 121 determines whether the setting change control has been authenticated (step S112). That is, the authentication unit 121 determines whether the setting change control is valid as a result of the authentication. For example, the authentication unit 121 may determine that the setting change control is valid in a case where the transmission source of the setting change control is the valid control device 20 or in a case where the value of the setting change control is a valid value.

In a case where the authentication has been performed, the authentication unit 121 permits the setting change based on the authenticated setting change control. In this case, the authentication unit 121 notifies the interruption unit 122 that the received setting change control is the authenticated setting change control (step S113). On the other hand, in a case where the authentication has not been performed, the authentication unit 121 does not permit the setting change based on the received setting change control. In this case, the authentication unit 121 notifies the interruption unit 122 that the received setting change control is the setting change control that has not been authenticated (step S114).

Thereafter, the interruption unit 122 determines whether the interruption release condition is satisfied on the basis of the notification (whether the received setting change control is the authenticated setting change control) from the authentication unit 121 (step S115). In the case of determining that the interruption release condition is satisfied (step S115: YES), the interruption unit 122 releases the interruption of the communication of the main signal. Note that, in a case where the transmission has been being unpermitted, the interruption unit 122 permits the transmission of the main signal (step S107).

On the other hand, in the case of determining that the interruption release condition is not satisfied (step S115: NO), the interruption unit 122 interrupts the communication of the main signal (step S108). Note that, in a case where the transmission has been being permitted, the interruption unit 122 does not permit the transmission of the main signal.

Note that, in a case where the authentication of the setting change control is canceled during the communication between the transceiver accommodation device 10 and the control device 20, the interruption unit 122 may determine that the interruption release condition is not satisfied.

According to the communication system 1a configured as described above, the transmission or the setting change is permitted in the case where the control from the authenticated control device 20 or the authenticated setting change control has arrived at the transceiver accommodation device 10, and the transmission or the setting change is not permitted in the case where the control from the unauthenticated device or the unauthenticated setting change control has arrived at the transceiver accommodation device 10.e As a result, it is possible to suppress an influence of an operation against the intention of the telecommunications carrier regarding a business telecommunication facility installed in the user's house.

Moreover, in the transceiver accommodation device 10, the user is permitted to perform setting change of the transceiver accommodation device 10 other than some setting change that should be managed on the communication network side. As described above, the transceiver accommodation device 10 accepts the setting change by the user for the setting that the user may change while suppressing only the setting change that the user should not operate. Therefore, the degree of freedom of software configuration change can be left for the user.

In access restriction that makes it difficult for the user to access, for example, a signal route that can control a predetermined state of the main signal transmission/reception unit 12 is disconnected. The authentication unit or the like may not give an address for identifying such a signal route to the user-side control terminal 30. The authentication unit 121 or the like may not give an address to the user and may not respond to an inquiry from the user (for example, “ping”) for identifying the address. In a case where there has been a dictionary attack, the authentication unit 121 or the like may detect that there has been the dictionary attack. In a case where the reception control unit 141 does not exchange the control information through the management port of the transceiver accommodation device 10, the authentication unit 121 or the like may not permit access from a specific port (for example, a serial port) such as the management port of the transceiver accommodation device 10. A replacement/addition restriction unit 143 may not permit a user session (access) from teletype (tty) or the like in a case where “tty” that does not use the teletype (tty) or the like is used as the control signal.

Note that a login control function for controlling login from the user-side control terminal 30 may be provided. Specifically, the login control function permits the communication transmission in a case where disabling of login from the user-side control terminal 30 is maintained, and disables the login from the user-side control terminal 30 again in a case where disabling of the login from the user-side control terminal 30 is not maintained.

In this configuration, the interruption unit 122 further has a function to interrupt the communication transmission in a case where disabling of login from the user-side control terminal 30 is not maintained, and to release the interruption of the communication transmission in a case where disabling of the login from the user-side control terminal 30 is maintained.

In this case, the reception control unit 141, the login control function, and the interruption unit 122 may be arranged in the control signal transmission/reception unit 11 or the main signal transmission/reception unit 12. In this case, since the processing can be performed in a close manner in the control signal transmission/reception unit 11 or the main signal transmission/reception unit 12 without software of the transceiver accommodation device 10, there are few loopholes for responding to an operation against the intention of the telecommunications carrier, and it is possible to quickly respond to an operation against the intention of the telecommunications carrier.

If the login control function is in the transceiver accommodation device 10, the transceiver accommodation device 10 quickly responds to enable/disable login of a local user.

If the reception control unit 141 is in the transceiver accommodation device 10, the transceiver accommodation device 10 quickly responds to enable/disable communication on the communication network side with the control device 20.

If the interruption unit 122 and the login control function are in the transceiver accommodation device 10, the transceiver accommodation device 10 quickly responds to enable/disable login of the local user.

If the interruption unit 122 and the reception control unit 141 are in the transceiver accommodation device 10, the transceiver accommodation device 10 quickly responds to enable/disable communication on the communication network side with the control device 20.

If the login control function is in the transceiver accommodation device 10, the communication network quickly responds to enable/disable login of the local user on the communication network side.

If the interruption unit 122 and the login control function are in the transceiver accommodation device 10, the communication network quickly responds to enable/disable login of the local user on the communication network side.

In the access restriction that makes it difficult for the user to log in in a case where the user logs in with an ID and a password in the user-side control terminal 30, for example, a signal route that can control a predetermined state of the main signal transmission/reception unit 12 is disconnected. The login control function may not give an address for identifying such a signal route to the user-side control terminal 30. The login control function may not give an address from the user and may not respond to an inquiry (for example, “ping”) for identifying the address. In a case where there has been a dictionary attack, the login control function may detect that there has been the dictionary attack.

A setting unit executes setting of the main signal transmission/reception unit 12 according to the control signal (instruction) from other than the user-side control terminal 30 with respect to the predetermined related settings of the main signal transmission/reception unit 12. For example, the setting unit executes the settings of the main signal transmission/reception unit 12 according to only the control signal (instruction) from the control device 20 with respect to the predetermined related settings of the main signal transmission/reception unit 12. Here, the setting unit changes and reads the predetermined related settings of the main signal transmission/reception unit 12 on the basis of only the control signal from the control device 20.

In a case where control is performed via management, the login control function may not permit an access from a specific port (for example, a serial port) or the like. In a case where “tty” is used as the control signal, the login control function may not permit a user session (access) from teletype (tty) or the like.

### Modification 1

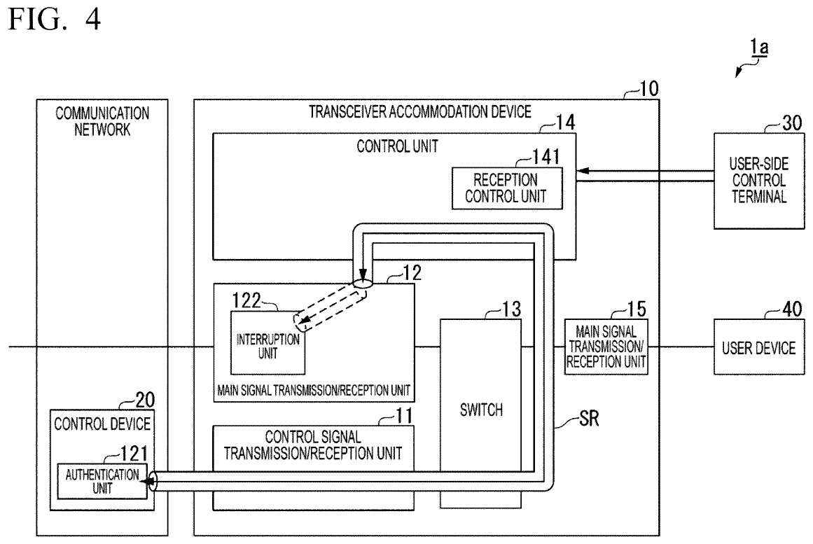

As illustrated in FIG. 4, the main signal transmission/reception unit 12 of the transceiver accommodation device 10 may include only the interruption unit 122, and the authentication unit 121 may be included in the control device 20. In such a configuration, the authentication unit 121 included in the control device 20 and the transceiver accommodation device 10 may communicate via the control signal route SR. The reception control unit 141 constructs the control signal route SR between the control device 20 and the interruption unit 122 in the main signal transmission/reception unit 12. Note that, in a case where the inside of the main signal transmission/reception unit 12 is in a secure environment, the reception control unit 141 may construct the control signal route SR between the control device 20 and the main signal transmission/reception unit 12, and may not construct the control signal route SR in a route indicated by the broken line in the main signal transmission/reception unit 12 illustrated in FIG. 4 (a route from the main signal transmission/reception unit 12 to the interruption unit 122 in the main signal transmission/reception unit 12). When the authentication unit 121 is in the control device 20, a response on the communication network side in a case where an abnormality is detected by the authentication unit 121 or in a case where the detected abnormality cannot be corrected, for example, interruption in a case where the interruption unit 122 is on the communication network side is quick.

Note that the authentication unit 121 is not limited to be provided inside the control device 20, and may be provided anywhere in the communication network. In this case, the vicinity of the control device 20 or inside or near an operation system that controls the communication network is favorable. Note that, in the case where the authentication unit 121 is included in a device other than the control device 20, it is assumed that the communication network is configured to be hardly cracked.

In the example illustrated in FIG. 4, the control device 20 on the communication network side is not an authentication target, and the setting change control is an authentication target. Alternatively, the main signal transmission/reception unit 12 itself or the transceiver accommodation device 10 itself is an authentication target.

In the case where the setting change control is the authentication target, the authentication unit 121 assigns a value of an electronic signature to the held value of the control and authenticates the validity of the signature, or assigns a value such as an electronic signature at the time of control and authenticates an interaction of the assignment. In the case where the main signal transmission/reception unit 12 itself or the transceiver accommodation device 10 itself is the authentication target, the authentication unit 121 authenticates that the main signal transmission/reception unit 12 itself or the transceiver accommodation device 10 itself is in an uncracked appropriate state and is only appropriately controlled. These authentication statuses are sequentially notified from the authentication unit 121 on the communication network side to the main signal transmission/reception unit 12 or the transceiver accommodation device 10, and the communication is interrupted in the main signal transmission/reception unit 12 or the transceiver accommodation device 10 due to detection of abnormality, uncorrectable abnormality (within a predetermined time), and stop of notification of the authentication state (for a predetermined time).

### Second Modification

In the above-described embodiment, the configuration in which the control signal transmitted from the control device 20 is received via the control signal transmission/reception unit 11 has been described. However, the main signal transmission/reception unit 12 may be configured to exchange the control signal using a predetermined client signal, a GCC channel for control signal, AMCC, or the like. In such a configuration, the reception control unit 141 may construct the control signal route SR between the main signal transmission/reception unit 12 and the control device 20. In the case where the control signal route SR is constructed between the main signal transmission/reception unit 12 and the control device 20, the reception control unit 141 constructs the control signal route SR after communication transmission between the transceiver accommodation device 10 and the opposing device is permitted.

### Second Embodiment

In a second embodiment, as an example, a configuration in which a control device 20 includes an interruption unit 210 will be described.

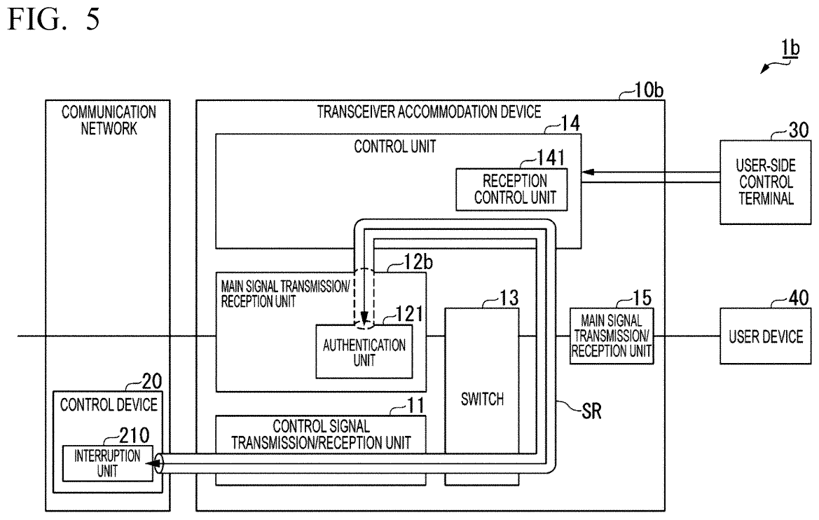

FIG. 5 is a diagram illustrating a configuration example of a communication system 1b according to the second embodiment. The communication system 1b includes a transceiver accommodation device 10b and the control device 20. A user-side control terminal 30 is connected to the transceiver accommodation device 10b via a serial bus. Moreover, a user device 40 is connected to the transceiver accommodation device 10b. Note that the user-side control terminal 30 may be connected to the transceiver accommodation device 10b by another method instead of the serial bus.

The transceiver accommodation device 10b is provided in a user's house. The transceiver accommodation device 10b includes, for example, a white box switch in which software is installed, a transceiver for transmitting and receiving a main signal, and a transceiver for transmitting and receiving a control signal. The transceiver accommodation device 10b includes a control signal transmission/reception unit 11, a main signal transmission/reception unit 12b, a switch 13, a control unit 14, and a main signal transmission/reception unit 15. The main signal transmission/reception unit 12b includes an authentication unit 121.

The control unit 14 performs control related to at least the main signal transmission/reception unit 12b. The control unit 14 implements functions of a reception control unit 141 by one or more processors executing a program.

In the second embodiment, the main signal transmission/reception unit 12b includes only the authentication unit 121. Further, the control device 20 includes an interruption unit 210. In such a configuration, the interruption unit 210 included in the control device 20 and the transceiver accommodation device 10b may communicate via a control signal route SR.

Note that the interruption unit 210 may be provided anywhere in a communication network, other than inside the control device 20. In this case, the vicinity of the control device 20 or inside or near an operation system that controls the communication network is favorable. Note that, in the case where the interruption unit 210 is included in a device other than the control device 20, it is assumed that the communication network is configured to be hardly cracked. In a case where the interruption unit 210 interrupts a main signal output from the main signal transmission/reception unit 12b of the transceiver accommodation device 10b in the communication network, the interruption unit 210 is desirably arranged on a flow line of the main signal. In a case where the interruption unit 210 instructs the main signal transmission/reception unit 12b to stop or interrupt power supply, causes the transceiver accommodation device 10b to turn off power supply of the main signal transmission/reception unit 12b, causes the switch 13 to interrupt signal transmission between the main signal transmission/reception unit 12b on the communication network side and the main signal transmission/reception unit 15 on the user device 40 side, or turns off power supply of the transceiver accommodation device 10b itself, the interruption unit 210 is desirably included in the control device 20 as illustrated in FIG. 5.

In the case of the configuration illustrated in FIG. 5, the reception control unit 141 constructs a control signal route SR between the control device 20 and the authentication unit 121 in the main signal transmission/reception unit 12b. Note that, in a case where an inside of the main signal transmission/reception unit 12b is in a secure environment, the reception control unit 141 may construct a control signal route SR between the control device 20 and the main signal transmission/reception unit 12b, and may not construct the control signal route SR in a route indicated by the broken line in the main signal transmission/reception unit 12b illustrated in FIG. 5 (a route from the main signal transmission/reception unit 12b to the authentication unit 121 in the main signal transmission/reception unit 12b).

The authentication unit 121 authenticates setting change control for changing settings related to the control device 20 or the main signal transmission/reception unit 12b. In the authentication, a serial number may be used as an authentication key in a certain manner, such as MAC address authentication. In this case, a less easily falsified configuration such as a configuration to limit the authentication to readout from an appropriate register is desirable. In addition, a protocol of IEEE802.1x may be used for authentication, a RADIUS server or the like may be used for authentication, and an ID/Password, a certificate, or a SIM card may be used as an authentication key. In this case, an authentication key may be inserted into the main signal transmission/reception unit 12b and distributed.

The main signal transmission/reception unit 12b implements a function of the authentication unit 121 by the one or more processors executing the program. Note that the functions of the authentication unit 121 may be implemented by only hardware or may be implemented by a combination of hardware and a processor. In the case where the functions of the authentication unit 121 are implemented by a combination of hardware and a processor, a part of the functions of the authentication unit 121 may be implemented by the processor, and the other functions may be implemented by the hardware.

The interruption unit 210 interrupts communication of the main signal when an interruption condition is satisfied. The interruption unit 210 implements functions of the interruption unit 210 by one or more processors executing a program. Note that the interruption unit 210 may perform the interruption when the control device 20 on the communication network side cannot normally interact with the transceiver accommodation device 10 or when abnormal traffic flows into the communication network. The abnormal traffic is traffic that does not meet a value of a predetermined related setting. For example, the abnormal traffic is an inappropriate wavelength signal in a case where a set value of the related setting is a wavelength, or is a signal having an inappropriate high intensity or low intensity in a case where a set value of the related setting is an intensity. Moreover, the interruption unit 210 may have a function to hold setting information obtained by receiving the control signal including a setting instruction transmitted from the control device 20 or performing snooping, and may perform the interruption when setting, setting confirmation, or the like cannot be performed for the held setting information, when a setting abnormality is notified or detected, when a setting is rewritten from a route other than the route of the communication network (for example, a route other than a control signal route SR), or when a phenomenon to be rewritten has occurred.

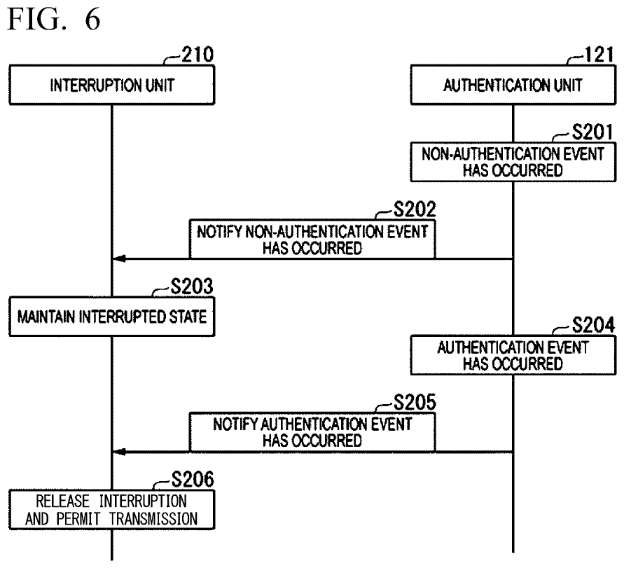

FIG. 6 is a sequence diagram illustrating a flow of processing performed by the communication system 1b according to the second embodiment.

This sequence diagram illustrates processing after the reception control unit 141 of the transceiver accommodation device 10b constructs the control signal route SR between the transceiver accommodation device 10b and the control device 20b before communication transmission between the transceiver accommodation device 10b and the opposing device is permitted. Note that, at the start of processing in FIG. 6, communication of the main signal between the transceiver accommodation device 10 and the control device 20 is in an interrupted state.

In the authentication unit 121, a non-authentication event may occur. For example, the user-side control terminal 30 may attempt intrusion of a computer virus. For example, the user-side control terminal 30 may attempt to update software. The authentication unit 121 determines occurrence. For example, since the user-side control terminal 30 may execute the non-authentication event from the user-side control terminal 30, the authentication unit 121 detects the non-authentication event. For example, the authentication unit 121 may detect the intrusion of a computer virus or cracking.

For example, the authentication unit 121 may detect software update. When detecting the occurrence of the non-authentication event, intrusion of a computer virus, or cracking (step S201), the authentication unit 121 transmits a non-authentication event occurrence notification indicating that the non-authentication event has occurred to the interruption unit 210 (step S202). Here, the non-authentication event indicates an event in which connection with the control device 20 authenticated by the authentication unit 121 has been disconnected or an event in which setting control not authenticated by the authentication unit 121 has arrived. In addition, an authentication event to be described below is an event in which the connection with the control device 20 authenticated by the authentication unit 121 has been restored, or an event in which the authenticated setting control has arrived.

When receiving the non-authentication event occurrence notification, the interruption unit 210 maintains an interrupted state (step S203).

On the other hand, when the authentication event has occurred (step S204), the authentication unit 121 transmits an authentication event occurrence notification indicating that the authentication event has occurred to the interruption unit 210 (step S205). When receiving the authentication event occurrence notification, the interruption unit 210 releases interruption of communication of the main signal and permits transmission (step S206).

According to the communication system 1b in the second embodiment configured as described above, it is possible to obtain effects similar to those of the first embodiment.

Note that a login control function for controlling login from the user-side control terminal 30 may be provided. Specifically, the login control function permits the communication transmission in a case where disabling of login from the user-side control terminal 30 is maintained, and disables the login from the user-side control terminal 30 again in a case where disabling of the login from the user-side control terminal 30 is not maintained.

In this configuration, the interruption unit 122 further has a function to interrupt the communication transmission in a case where disabling of login from the user-side control terminal 30 is not maintained, and to release the interruption of the communication transmission in a case where disabling of the login from the user-side control terminal 30 is maintained.

In this case, the reception control unit 141, the login control function, and the interruption unit 122 may be arranged in the control signal transmission/reception unit 11 or the main signal transmission/reception unit 12b. In this case, since processing can be performed in a close manner in the control signal transmission/reception unit 11 or the main signal transmission/reception unit 12b without software of the transceiver accommodation device 10b, there are few loopholes for responding to an operation against an intention of a telecommunications carrier, and it is possible to quickly respond to an operation against the intention of the telecommunications carrier.

If the login control function is in the transceiver accommodation device 10b, the transceiver accommodation device 10b quickly responds to enable/disable login of a local user.

If the reception control unit 141 is in the transceiver accommodation device 10b, the transceiver accommodation device 10b quickly responds to enable/disable communication on the communication network side with the control device 20.

If the interruption unit 122 and the login control function are in the transceiver accommodation device 10b, the transceiver accommodation device 10b quickly responds to enable/disable login of the local user.

If the interruption unit 122 and the reception control unit 141 are in the transceiver accommodation device 10b, the transceiver accommodation device 10b quickly responds to enable/disable communication on the communication network side with the control device 20.

If the login control function is in the transceiver accommodation device 10b, the communication network quickly responds to enable/disable login of the local user on the communication network side.

If the interruption unit 122 and the login control function are in the transceiver accommodation device 10b, the communication network quickly responds to enable/disable login of the local user on the communication network side.

In the access restriction that makes it difficult for the user to log in in a case where the user logs in with an ID and a password in the user-side control terminal 30, for example, a signal route that can control a predetermined state of the main signal transmission/reception unit 12 is disconnected. The login control function may not give an address for identifying such a signal route to the user-side control terminal 30. The login control function may not give an address from the user and may not respond to an inquiry (for example, “ping”) for identifying the address. In a case where there has been a dictionary attack, the login control function may detect that there has been the dictionary attack. In a case where control is performed via management, the login control function may not permit an access from a specific port (for example, a serial port) or the like. In a case where “tty” is used as the control signal, the login control function may not permit a user session (access) from teletype (tty) or the like.

### Third Embodiment

In a third embodiment, as an example, a configuration in which a main signal transmission/reception unit of a transceiver accommodation device includes only an authentication unit will be described. Note that, in the third embodiment, neither the transceiver accommodation device nor a communication network includes an interruption unit.

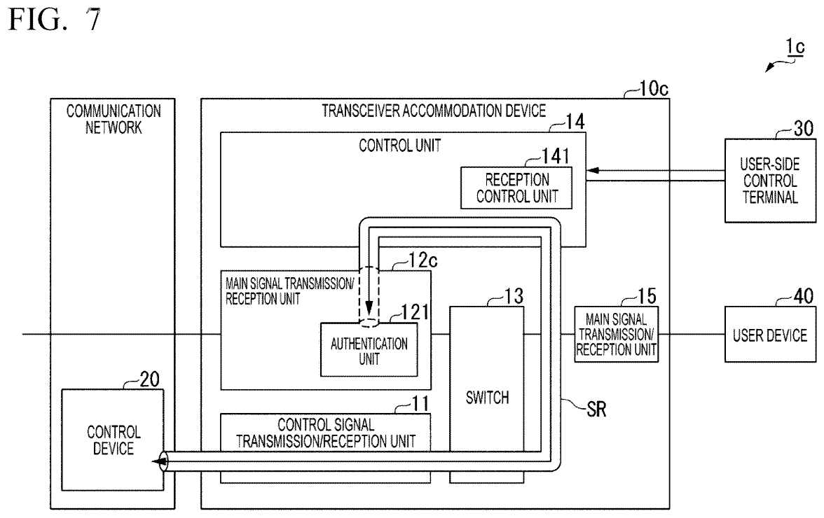

FIG. 7 is a diagram illustrating a configuration example of a communication system 1c according to the third embodiment. The communication system 1c includes a transceiver accommodation device 10c and a control device 20. A user-side control terminal 30 is connected to the transceiver accommodation device 10c via a serial bus. Moreover, a user device 40 is connected to the transceiver accommodation device 10c. Note that the user-side control terminal 30 may be connected to the transceiver accommodation device 10c by another method instead of the serial bus.

The transceiver accommodation device 10c is provided in a user's house. The transceiver accommodation device 10c includes, for example, a white box switch in which software is installed, a transceiver for transmitting and receiving a main signal, and a transceiver for transmitting and receiving a control signal. The transceiver accommodation device 10c includes a control signal transmission/reception unit 11, a main signal transmission/reception unit 12c, a switch 13, a control unit 14, and a main signal transmission/reception unit 15. The main signal transmission/reception unit 12c includes an authentication unit 121.

The control unit 14 performs control related to at least the main signal transmission/reception unit 12c. The control unit 14 implements the functions of the reception control unit 141 by the one or more processors executing the program. For example, the reception control unit 141 constructs a control signal route SR between the control device 20 and the authentication unit 121 in the main signal transmission/reception unit 12c. Note that, in a case where an inside of the main signal transmission/reception unit 12c is in a secure environment, the reception control unit 141 may construct a control signal route SR between the control device 20 and the main signal transmission/reception unit 12c, and may not construct the control signal route SR in a route indicated by the broken line in the main signal transmission/reception unit 12c illustrated in FIG. 7 (a route from the main signal transmission/reception unit 12c to the authentication unit 121 in the main signal transmission/reception unit 12c).

In the third embodiment, the main signal transmission/reception unit 12c includes only the authentication unit 121. The authentication unit 121 authenticates setting change control for changing settings related to the control device 20 or the main signal transmission/reception unit 12c. Since the function to perform authentication by the authentication unit 121 is similar to that of the first embodiment and the second embodiment, description thereof is omitted.

In the third embodiment, the authentication unit 121 permits transmission in a case where the control device 20 has been authenticated or in a case where authenticated setting change control has arrived. On the other hand, in the third embodiment, the authentication unit 121 does not permit transmission in a case where the control device 20 has not been authenticated or in a case where unauthenticated setting change control has arrived.

The main signal transmission/reception unit 12c implements a function of the authentication unit 121 by the one or more processors executing the program. Note that the functions of the authentication unit 121 may be implemented by only hardware or may be implemented by a combination of hardware and a processor. In the case where the functions of the authentication unit 121 are implemented by a combination of hardware and a processor, a part of the functions of the authentication unit 121 may be implemented by the processor, and the other functions may be implemented by the hardware.

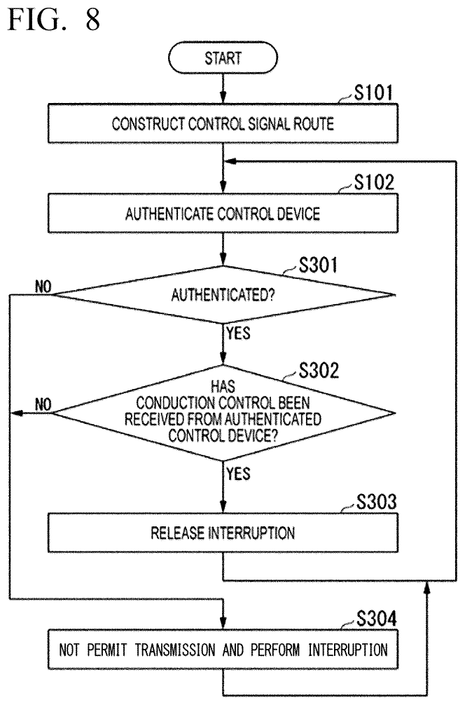

FIG. 8 is a flowchart illustrating a flow of processing of the transceiver accommodation device 10c in the third embodiment. In FIG. 8, processing steps similar to those in FIG. 3 will be denoted by similar reference signs to those used in FIG. 3, and description thereof will be omitted.

After processing from step S101 to step S102 is performed, the authentication unit 121 determines whether the control device 20 has been authenticated (step S301). In a case of determining that the control device 20 has been authenticated (step S301: YES), the authentication unit 121 determines whether transmission has been controlled from the authenticated control device 20 (step S302). In a case of determining that the transmission has been controlled from the authenticated control device 20 (step S302: YES), the authentication unit 121 permits the transmission (step S303), and returns to step S102.

On the other hand, in a case of determining that the control device 20 has not been authenticated, or in a case where the transmission has not been controlled from the authenticated control device 20 (step S301: NO, or Step S302: NO), the authentication unit 121 does not permit the transmission and performs interruption (step S304), and the processing returns to step S102.

According to the communication system 1c configured as described above, in the case where the control device 20 has not been authenticated or in the case where the unauthenticated setting change control has arrived, the transmission is not permitted and is interrupted. As a result, it is possible to suppress an influence of an operation against the intention of the telecommunications carrier regarding a business telecommunication facility installed in the user's house.

### Fourth Embodiment

In a fourth embodiment, as an example, a configuration in which a control unit of a transceiver accommodation device includes an authentication unit will be described. Note that, in the fourth embodiment, neither the transceiver accommodation device nor a communication network includes an interruption unit.

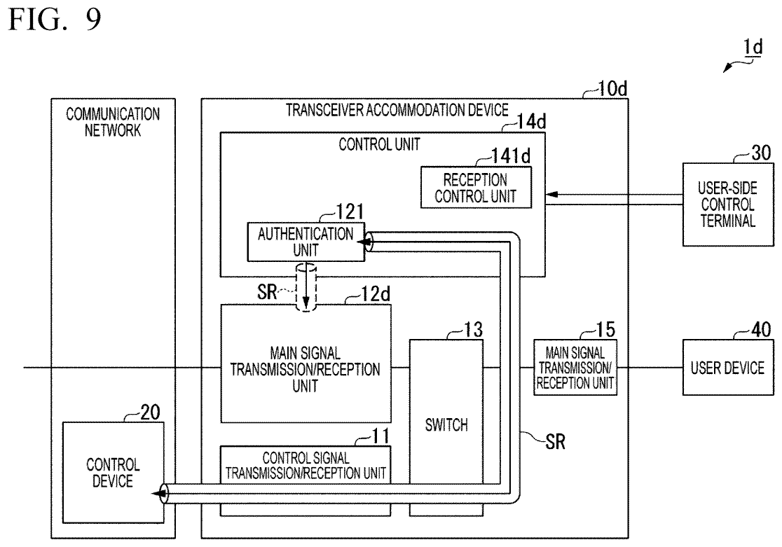

FIG. 9 is a diagram illustrating a configuration example of a communication system 1d in the fourth embodiment. The communication system 1d includes a transceiver accommodation device 10d and a control device 20. A user-side control terminal 30 is connected to the transceiver accommodation device 10d via a serial bus. Moreover, a user device 40 is connected to the transceiver accommodation device 10d. Note that the user-side control terminal 30 may be connected to the transceiver accommodation device 10d by another method instead of the serial bus.

The transceiver accommodation device 10d is provided in a user's house. The transceiver accommodation device 10d includes, for example, a white box switch in which software is installed, a transceiver for transmitting and receiving a main signal, and a transceiver for transmitting and receiving a control signal. The transceiver accommodation device 10d includes a control signal transmission/reception unit 11, a main signal transmission/reception unit 12d, a switch 13, a control unit 14d, and a main signal transmission/reception unit 15. The control unit 14d includes a reception control unit 141d and an authentication unit 121.

The control unit 14d performs control related to at least the main signal transmission/reception unit 12d. The control unit 14d implements functions of the reception control unit 141d and the authentication unit 121 by one or more processors executing a program.

The reception control unit 141d performs processing similar to the above-described reception control unit 141. For example, the reception control unit 141d constructs a control signal route SR between the control device 20 and the authentication unit 121 in the control unit 14d and between the authentication unit 121 and the main signal transmission/reception unit 12d. Note that, in a case where an environment between the control unit 14d and the main signal transmission/reception unit 12d is secure, the reception control unit 141d may not construct the control signal route SR in a route indicated by the broken line between the control unit 14d and the main signal transmission/reception unit 12d illustrated in FIG. 9. Here, the secure environment between the control unit 14d and the main signal transmission/reception unit 12d is an environment in which at least interaction between the control unit 14d and the main signal transmission/reception unit 12d is not intercepted or data is not falsified.

The authentication unit 121 performs processing similar to the authentication unit 121 described in the first embodiment and the second embodiment. Specifically, the authentication unit 121 authenticates setting change control for changing settings related to the control device 20 or the main signal transmission/reception unit 12d. Since the function to perform authentication by the authentication unit 121 is similar to that of the first embodiment and the second embodiment, description thereof is omitted.

The main signal transmission/reception unit 12d is a transceiver for the main signal. The main signal transmission/reception unit 12d does not include the authentication unit 121 and the interruption unit 122 as compared with the main signal transmission/reception unit 12 in the first embodiment. The main signal transmission/reception unit 12d transmits and receives the main signal such as an optical signal to and from an opposing device via the communication network. The main signal transmission/reception unit 12d converts the received main signal into an electrical signal and outputs the electrical signal to the switch 13. The main signal transmission/reception unit 12d is usually a replaceable transceiver.

Processing performed by the transceiver accommodation device 10d in the fourth embodiment is similar to that in the third embodiment except that an output destination of the control signal via the control signal route SR is different. Specifically, in the third embodiment, the control signal has been output to the authentication unit 121 included in the main signal transmission/reception unit 12c via the control signal route SR, whereas in the fourth embodiment, the control signal is output to the authentication unit 121 included in the control unit 14d via the control signal route SR.

According to the communication system 1d configured as described above, transmission is not permitted in a case where the control device 20 is not authenticated or in a case where transmission is not controlled from the authenticated control device 20. As a result, it is possible to suppress an influence of an operation against the intention of the telecommunications carrier regarding a business telecommunication facility installed in the user's house.

### Fifth Embodiment

In a fifth embodiment, as an example, a configuration in which a control unit of a transceiver accommodation device includes an interruption unit and a main signal transmission/reception unit includes an authentication unit will be described.

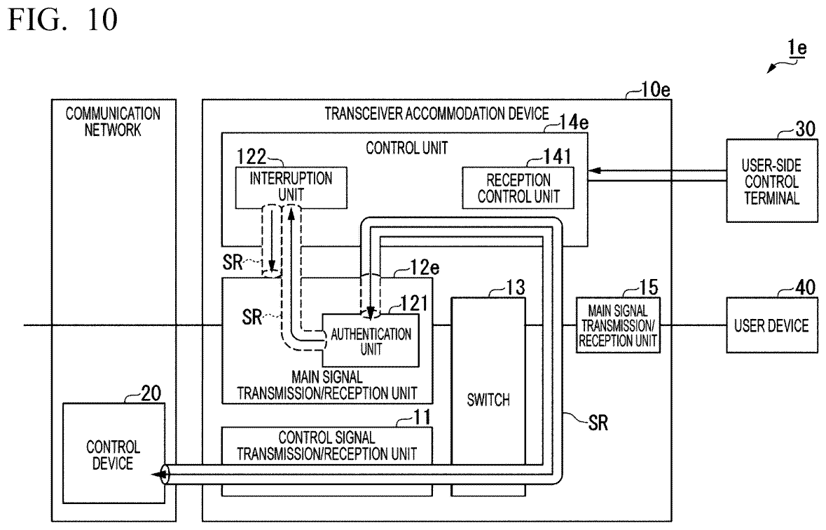

FIG. 10 is a diagram illustrating a configuration example of a communication system 1e in the fifth embodiment. The communication system 1e includes a transceiver accommodation device 10e and a control device 20. A user-side control terminal 30 is connected to the transceiver accommodation device 10e via a serial bus. Moreover, a user device 40 is connected to the transceiver accommodation device 10e. Note that the user-side control terminal 30 may be connected to the transceiver accommodation device 10e by another method instead of the serial bus.

The transceiver accommodation device 10e is provided in a user's house. The transceiver accommodation device 10e includes, for example, a white box switch in which software is installed, a transceiver for transmitting and receiving a main signal, and a transceiver for transmitting and receiving a control signal. The transceiver accommodation device 10e includes a control signal transmission/reception unit 11, a main signal transmission/reception unit 12e, a switch 13, a control unit 14e, and a main signal transmission/reception unit 15. The main signal transmission/reception unit 12e includes an authentication unit 121. The control unit 14e includes a reception control unit 141 and an interruption unit 122.

In a case where the authentication unit 121 is included in the main signal transmission/reception unit 12e and the interruption unit 122 is included in the control unit 14e of the transceiver accommodation device 10e, detection of abnormality or uncorrectable abnormality (within a predetermined time) needs to be notified from the main signal transmission/reception unit 12e to the transceiver accommodation device 10e to be interrupted. Therefore, it takes time to perform interruption by the notification. In addition, in a case where a notification route is disconnected, the interruption is difficult. Therefore, the notification route disconnection is also desirably detected as abnormality and interrupted by the interruption unit 122. Note that, in a case where the interruption unit 122 interrupts the main signal itself output from the main signal transmission/reception unit 12e, the interruption is difficult in a case where a control route from the transceiver accommodation device 10e to the main signal transmission/reception unit 12e is disconnected. Therefore, it is desirable to perform the interruption in the transceiver accommodation device 10e. Similarly, it is also difficult to perform control so as to perform interruption on the communication network side.

In a case where the authentication unit 121 is included in the main signal transmission/reception unit 12e and the interruption unit 122 is included in the control unit 14e of the transceiver accommodation device 10e, detection of abnormality, detection of uncorrectable abnormality (within a predetermined time), or detection of reception of response of authentication completion within a predetermined time needs to be notified from the main signal transmission/reception unit 12e to the transceiver accommodation device 10e to be interrupted. Therefore, it takes time to perform interruption by the notification. In addition, in a case where a notification route is disconnected, the interruption is difficult. Therefore, the notification route disconnection is also desirably detected as abnormality and interrupted by the interruption unit 122. Note that, in a case where the interruption unit 122 interrupts the main signal itself output from the main signal transmission/reception unit 12e, the interruption is difficult in a case where a control route from the transceiver accommodation device 10e to the main signal transmission/reception unit 12e is disconnected. Therefore, it is desirable to perform the interruption in the transceiver accommodation device 10e. Similarly, it is also difficult to perform control so as to perform interruption on the communication network side.

The control unit 14e performs control related to at least the main signal transmission/reception unit 12e. The control unit 14e implements functions of the reception control unit 141 and the interruption unit 122 by one or more processors executing a program.

The reception control unit 141 constructs a control signal route SR between the control device 20 and the authentication unit 121 in the main signal transmission/reception unit 12e, between the authentication unit 121 in the main signal transmission/reception unit 12e and the interruption unit 122 in the control unit 14e, and between the interruption unit 122 in the control unit 14e and the main signal transmission/reception unit 12e. Note that, in a case where an inside of the main signal transmission/reception unit 12e is in a secure environment, the reception control unit 141 may construct a control signal route SR between the control device 20 and the main signal transmission/reception unit 12e, and may not construct the control signal route SR in a route indicated by the broken line in the main signal transmission/reception unit 12e illustrated in FIG. 10 (a route from the main signal transmission/reception unit 12e to the authentication unit 121 in the main signal transmission/reception unit 12e). Note that, in a case where an environment between the control unit 14e and the main signal transmission/reception unit 12e is secure, the reception control unit 141 may not construct the control signal route SR in a route indicated by the broken line between the authentication unit 121 in the main signal transmission/reception unit 12e and the interruption unit 122 in the control unit 14e illustrated in FIG. 10 and a route indicated by the broken line between the interruption unit 122 in the control unit 14e and the main signal transmission/reception unit 12e illustrated in FIG. 10.

Here, the secure environment between the control unit 14e and the main signal transmission/reception unit 12e is an environment in which at least interaction between the control unit 14e and the main signal transmission/reception unit 12e is not intercepted or data is not falsified. The arrow extending from the interruption unit 122 to the main signal transmission/reception unit 12e represents the control signal from the interruption unit 122 to the main signal transmission/reception unit 12e in the case of interruption is performed by the main signal transmission/reception unit 12e. In a case where the main signal transmission/reception unit 12e does not perform the interruption, the reception control unit 141 does not need to construct the control signal route SR between the interruption unit 122 in the control unit 14e and the main signal transmission/reception unit 12e.

The interruption unit 122 performs processing similar to the interruption unit 122 described in the first embodiment and the second embodiment. Specifically, the interruption unit 122 interrupts the communication of the main signal when an interruption condition is satisfied. That is, the interruption unit 122 determines that the interruption condition is satisfied in a case where connection with the control device 20 authenticated by the authentication unit 121 is disconnected or in a case where the setting change control that is not authenticated by the authentication unit 121 has arrived. In this case, the interruption unit 122 interrupts the transmission between the main signal transmission/reception unit 12e and the control device 20 in the communication network.

The main signal transmission/reception unit 12e implements a function of the authentication unit 121 by the one or more processors executing the program. Note that the functions of the authentication unit 121 may be implemented by only hardware or may be implemented by a combination of hardware and a processor. In the case where the functions of the authentication unit 121 are implemented by a combination of hardware and a processor, a part of the functions of the authentication unit 121 may be implemented by the processor, and the other functions may be implemented by the hardware. The authentication unit 121 authenticates any setting change control for changing settings related to the control device 20 or the main signal transmission/reception unit 12e.

Processing performed by the transceiver accommodation device 10e in the fifth embodiment is similar to that in the first embodiment except that the interruption unit 122 is included in the control unit 14e instead of in the main signal transmission/reception unit 12e, and thus description thereof is omitted.

According to the communication system 1e configured as described above, the communication of the main signal is interrupted in the case where the connection with the authenticated control device is disconnected or in the case where unauthenticated setting change control has arrived. As a result, it is possible to suppress an influence of an operation against the intention of the telecommunications carrier regarding a business telecommunication facility installed in the user's house.

### Sixth Embodiment

In a sixth embodiment, as an example, a configuration in which a control unit of a transceiver accommodation device includes an authentication unit and a main signal transmission/reception unit includes an interruption unit will be described.

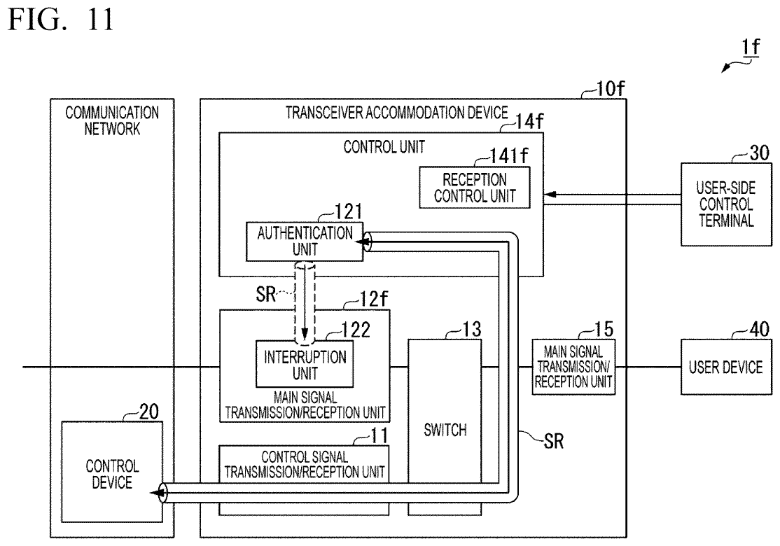

FIG. 11 is a diagram illustrating a configuration example of a communication system 1f in the sixth embodiment. The communication system 1f includes a transceiver accommodation device 10f and a control device 20. A user-side control terminal 30 is connected to the transceiver accommodation device 10f via a serial bus. Moreover, a user device 40 is connected to the transceiver accommodation device 10f. Note that the user-side control terminal 30 may be connected to the transceiver accommodation device 10f by another method instead of the serial bus.

The transceiver accommodation device 10f is included in a user's house. The transceiver accommodation device 10f includes, for example, a white box switch in which software is installed, a transceiver for transmitting and receiving a main signal, and a transceiver for transmitting and receiving a control signal. The transceiver accommodation device 10f includes a control signal transmission/reception unit 11, a main signal transmission/reception unit 12f, a switch 13, a control unit 14f, and a main signal transmission/reception unit 15. The main signal transmission/reception unit 12f includes an interruption unit 122. The control unit 14f includes a reception control unit 141f and an authentication unit 121.

In a case where the authentication unit 121 is included in the control unit 14f of the transceiver accommodation device 10f and the interruption unit 122 is included in the main signal transmission/reception unit 12f, detection of abnormality or uncorrectable abnormality (within a predetermined time) needs to be notified from the transceiver accommodation device 10f to the main signal transmission/reception unit 12f to be interrupted. Therefore, it takes time to perform interruption by the notification. In addition, in a case where a notification route is disconnected, the interruption is difficult. Therefore, the notification route disconnection is also desirably detected as abnormality and interrupted by the interruption unit 122. Note that, in a case where the interruption unit 122 interrupts the control to the transceiver accommodation device 10f, the interruption is difficult in a case where a control route from the main signal transmission/reception unit 12f to the transceiver accommodation device 10f is disconnected. Therefore, it is desirable to perform the interruption in the main signal transmission/reception unit 12f. Similarly, it is also difficult to perform control so as to perform interruption on the communication network side.

In a case where the authentication unit 121 is included in the control unit 14f of the transceiver accommodation device 10f and the interruption unit 122 is included in the main signal transmission/reception unit 12f, detection and interruption of abnormality or uncorrectable abnormality (within a predetermined time) are closed in the transceiver accommodation device 10f. Therefore, in a case where the interruption is performed by the control of the transceiver accommodation device 10f, it is possible to quickly perform interruption. Note that, in a case where the interruption of the interruption unit 122 is performed by controlling the transceiver accommodation device 10f or the communication network side, the interruption is difficult in a case where a control route from the transceiver accommodation device 10f to the main signal transmission/reception unit 12f or to the communication network side is interrupted. Therefore, it is desirable to perform the interruption in the transceiver accommodation device 10f.

In a case where the authentication unit 121 is included in the control unit 14f of the transceiver accommodation device 10f and the interruption unit 122 is included in the main signal transmission/reception unit 12f, detection of abnormality, detection of uncorrectable abnormality (within a predetermined time), or detection of reception of response of authentication completion within a predetermined time needs to be notified from the transceiver accommodation device 10f to the main signal transmission/reception unit 12f to be interrupted. Therefore, it takes time to perform interruption by the notification. In addition, in a case where a notification route is disconnected, the interruption is difficult. Therefore, the notification route disconnection is also desirably detected as abnormality and interrupted by the interruption unit 122. Note that, in a case where the interruption unit 122 interrupts the control to the transceiver accommodation device 10f, the interruption is difficult in a case where a control route from the main signal transmission/reception unit 12f to the transceiver accommodation device 10f is disconnected. Therefore, it is desirable to perform the interruption in the main signal transmission/reception unit 12f. Similarly, it is also difficult to perform control so as to perform interruption on the communication network side.

In a case where the authentication unit 121 is included in the control unit 14f of the transceiver accommodation device 10f and the interruption unit 122 is included in the main signal transmission/reception unit 12f, detection of abnormality, detection of uncorrectable abnormality (within a predetermined time), or detection and interruption of reception of response of authentication completion within a predetermined time is closed in the transceiver accommodation device 10f. Therefore, in a case where the interruption is performed by the control of the transceiver accommodation device 10f, it is possible to quickly perform interruption. Note that, in a case where the interruption of the interruption unit 122 is performed by controlling the transceiver accommodation device 10f or the communication network side, the interruption is difficult in a case where a control route from the transceiver accommodation device 10f to the main signal transmission/reception unit 12f or to the communication network side is interrupted. Therefore, it is desirable to perform the interruption in the transceiver accommodation device 10f.

The control unit 14f performs control related to at least the main signal transmission/reception unit 12f. The control unit 14f implements functions of the reception control unit 141f and the authentication unit 121 by one or more processors executing a program.

The reception control unit 141f performs processing similar to the above-described reception control unit 141. The reception control unit 141f constructs a control signal route SR between the control device 20 and the authentication unit 121 in the control unit 14f, and between the authentication unit 121 in the control unit 14f and the interruption unit 122 in the main signal transmission/reception unit 12f. Note that, in a case where an environment between the control unit 14f and the main signal transmission/reception unit 12f is secure, the reception control unit 141 may not construct the control signal route SR in a route indicated by the broken line between the authentication unit 121 in the control unit 14f and the interruption unit 122 in the main signal transmission/reception unit 12f illustrated in FIG. 11. Here, the secure environment between the control unit 14f and the main signal transmission/reception unit 12f is an environment in which at least interaction between the control unit 14f and the main signal transmission/reception unit 12f is not intercepted or data is not falsified.

The authentication unit 121 performs processing similar to the authentication unit 121 described in the first embodiment and the second embodiment. Specifically, the authentication unit 121 authenticates any setting change control for changing settings related to the control device 20 or the main signal transmission/reception unit 12f. Since the function to perform authentication by the authentication unit 121 is similar to that of the first embodiment and the second embodiment, description thereof is omitted.

The main signal transmission/reception unit 12f implements a function of the authentication unit 121 by the one or more processors executing the program. Note that the functions of the authentication unit 121 may be implemented by only hardware or may be implemented by a combination of hardware and a processor. In the case where the functions of the authentication unit 121 are implemented by a combination of hardware and a processor, a part of the functions of the authentication unit 121 may be implemented by the processor, and the other functions may be implemented by the hardware. The interruption unit 122 performs processing similar to the interruption unit 122 described in the first embodiment and the second embodiment. Specifically, the interruption unit 122 interrupts the communication of the main signal when an interruption condition is satisfied. That is, the interruption unit 122 determines that the interruption condition is satisfied in a case where connection with the control device 20 authenticated by the authentication unit 121 is disconnected or in a case where the setting change control that is not authenticated by the authentication unit 121 has arrived. In this case, the interruption unit 122 interrupts the transmission between the main signal transmission/reception unit 12f and the control device 20 in the communication network.

According to the communication system 1f configured as described above, the communication of the main signal is interrupted in the case where the connection with the authenticated control device is disconnected or in the case where unauthenticated setting change control has arrived. As a result, it is possible to suppress an influence of an operation against the intention of the telecommunications carrier regarding a business telecommunication facility installed in the user's house.

### Seventh Embodiment

In a seventh embodiment, as an example, a configuration in which a control unit of a transceiver accommodation device includes an authentication unit and an interruption unit will be described.

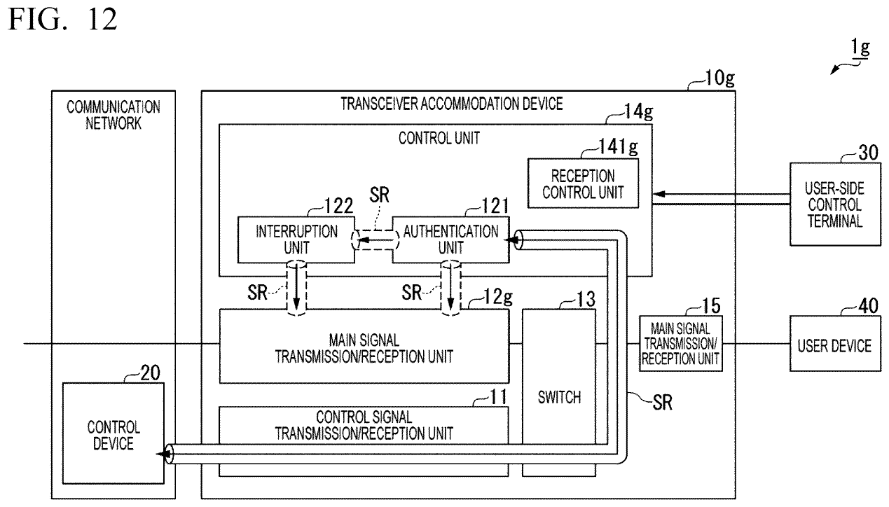

FIG. 12 is a diagram illustrating a configuration example of an optical communication system 1g according to the seventh embodiment. The communication system 1g includes a transceiver accommodation device 10g and a control device 20. A user-side control terminal 30 is connected to the transceiver accommodation device 10g via a serial bus. Moreover, a user device 40 is connected to the transceiver accommodation device 10g. Note that the user-side control terminal 30 may be connected to the transceiver accommodation device 10g by another method instead of the serial bus.

The transceiver accommodation device 10g is included in a user's house. The transceiver accommodation device 10g includes, for example, a white box switch in which software is installed, a transceiver for transmitting and receiving a main signal, and a transceiver for transmitting and receiving a control signal. The transceiver accommodation device 10g includes a control signal transmission/reception unit 11, a main signal transmission/reception unit 12g, a switch 13, a control unit 14g, and a main signal transmission/reception unit 15. The control unit 14g includes a reception control unit 141g, an authentication unit 121, and an interruption unit 122.

In a case where the authentication unit 121 and the interruption unit 122 are included in the control unit 14g of the transceiver accommodation device 10g, detection of abnormality or detection and interruption of uncorrectable abnormality (within a predetermined time) is closed in the transceiver accommodation device 10g. Therefore, in a case where the interruption is performed by the control of the transceiver accommodation device 10g, it is possible to quickly perform interruption. Note that, in a case where the interruption of the interruption unit 122 is performed by controlling the transceiver accommodation device 10g or the communication network side, the interruption is difficult in a case where a control route from the transceiver accommodation device 10g to the main signal transmission/reception unit 12g or to the communication network side is disconnected. Therefore, it is desirable to perform the interruption in the transceiver accommodation device 10g.

In a case where the authentication unit 121 and the interruption unit 122 are included in the control unit 14g of the transceiver accommodation device 10g, detection of abnormality, detection of uncorrectable abnormality (within a predetermined time), or detection and interruption of reception of response of authentication completion within a predetermined time is closed in the transceiver accommodation device 10g. Therefore, in a case where the interruption is performed by the control of the transceiver accommodation device 10g, it is possible to quickly perform interruption. Note that, in a case where the interruption of the interruption unit 122 is performed by controlling the transceiver accommodation device 10g or the communication network side, the interruption is difficult in a case where a control route from the transceiver accommodation device 10g to the main signal transmission/reception unit 12g or to the communication network side is disconnected. Therefore, it is desirable to perform the interruption in the transceiver accommodation device 10g.

The control unit 14g performs control related to at least the main signal transmission/reception unit 12g. The control unit 14g implements functions of the reception control unit 141g, the authentication unit 121, and the interruption unit 122 by one or more processors executing a program.

The reception control unit 141g performs processing similar to the above-described reception control unit 141. The reception control unit 141g constructs a control signal route SR between the control device 20 and the authentication unit 121 in the control unit 14g, between the authentication unit 121 and the interruption unit 122 in the control unit 14g, between the main signal transmission/reception unit 12g and the authentication unit 121 in the control unit 14g, and between the main signal transmission/reception unit 12g and the interruption unit 122 in the control unit 14g. Note that, in a case where an inside of the control unit 14g is in a secure environment, the reception control unit 141g may not construct the control signal route SR in a route indicated by the broken line between the authentication unit 121 and the interruption unit 122 in the control unit 14g illustrated in FIG. 12.

Note that, in a case where an environment between the control unit 14g and the main signal transmission/reception unit 12g is secure, the reception control unit 141g may not construct the control signal route SR in a route indicated by the broken line between the main signal transmission/reception unit 12g and the authentication unit 121 in the control unit 14g illustrated in FIG. 12, and a route indicated by the broken line between the main signal transmission/reception unit 12g and the interruption unit 122 in the control unit 14g illustrated in FIG. 12. Here, the secure environment between the control unit 14g and the main signal transmission/reception unit 12g is an environment in which at least interaction between the control unit 14g and the main signal transmission/reception unit 12g is not intercepted or data is not falsified.

The authentication unit 121 performs processing similar to the authentication unit 121 described in the first embodiment and the second embodiment. Specifically, the authentication unit 121 authenticates any setting change control for changing settings related to the control device 20 or the main signal transmission/reception unit 12g. Since the function to perform authentication by the authentication unit 121 is similar to that of the first embodiment and the second embodiment, description thereof is omitted.

The interruption unit 122 performs processing similar to the interruption unit 122 described in the first embodiment and the second embodiment. Specifically, the interruption unit 122 interrupts the communication of the main signal when an interruption condition is satisfied. That is, the interruption unit 122 determines that the interruption condition is satisfied in a case where connection with the control device 20 authenticated by the authentication unit 121 is disconnected or in a case where the setting change control that is not authenticated by the authentication unit 121 has arrived. In this case, the interruption unit 122 interrupts the transmission between the main signal transmission/reception unit 12g and the control device 20 in the communication network.

The main signal transmission/reception unit 12g is a transceiver for the main signal. The main signal transmission/reception unit 12g does not include the authentication unit 121 and the interruption unit 122 as compared with the main signal transmission/reception unit 12 in the first embodiment. The main signal transmission/reception unit 12g transmits and receives the main signal such as an optical signal to and from an opposing device via the communication network. The main signal transmission/reception unit 12g converts the received main signal into an electrical signal and outputs the electrical signal to the switch 13. The main signal transmission/reception unit 12g is usually a replaceable transceiver.

Processing performed by the transceiver accommodation device 10g in the seventh embodiment is similar to that in the first embodiment except that the authentication unit 121 and the interruption unit 122 are included in the control unit 14g instead of in the main signal transmission/reception unit 12g, and thus description thereof is omitted.

According to the communication system 1g configured as described above, the communication of the main signal is interrupted in the case where the connection with the authenticated control device is disconnected or in the case where unauthenticated setting change control has arrived. As a result, it is possible to suppress an influence of an operation against the intention of the telecommunications carrier regarding a business telecommunication facility installed in the user's house.

### Eighth Embodiment

In an eighth embodiment, as an example, a configuration in which a control unit of a transceiver accommodation device includes an authentication unit and a communication network includes an interruption unit 210 will be described.

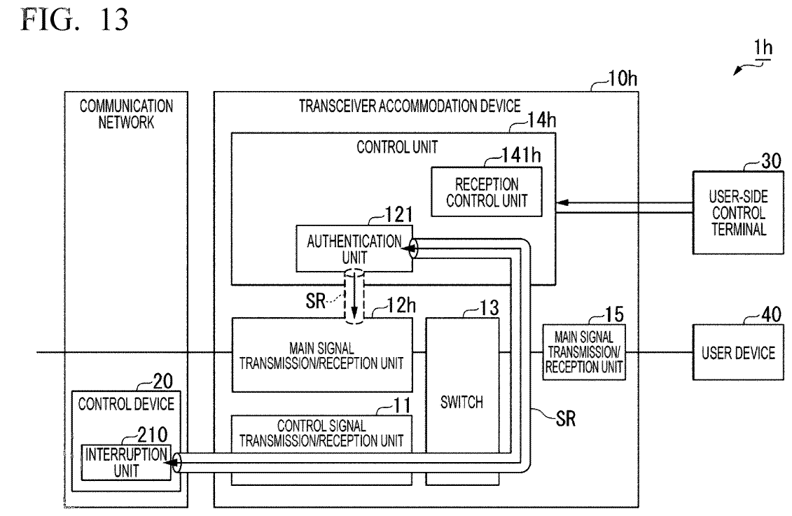

FIG. 13 is a diagram illustrating a configuration example of an optical communication system 1h according to the eighth embodiment. The communication system 1h includes a transceiver accommodation device 10h and a control device 20. A user-side control terminal 30 is connected to the transceiver accommodation device 10h via a serial bus. Moreover, a user device 40 is connected to the transceiver accommodation device 10h. Note that the user-side control terminal 30 may be connected to the transceiver accommodation device 10h by another method instead of the serial bus.

The transceiver accommodation device 10h is included in a user's house. The transceiver accommodation device 10h includes, for example, a white box switch in which software is installed, a transceiver for transmitting and receiving a main signal, and a transceiver for transmitting and receiving a control signal. The transceiver accommodation device 10h includes a control signal transmission/reception unit 11, a main signal transmission/reception unit 12h, a switch 13, a control unit 14h, and a main signal transmission/reception unit 15. The control unit 14h includes a reception control unit 141h and an authentication unit 121.

The control unit 14h performs control related to at least the main signal transmission/reception unit 12h. The control unit 14h implements functions of the reception control unit 141h and the authentication unit 121 by one or more processors executing a program.

The reception control unit 141h performs processing similar to the above-described reception control unit 141. For example, the reception control unit 141h constructs a control signal route SR between the control device 20 and the authentication unit 121 in the control unit 14h and between the main signal transmission/reception unit 12h and the authentication unit 121 in the control unit 14h. Note that, in a case where an environment between the control unit 14h and the main signal transmission/reception unit 12h is secure, the reception control unit 141h may not construct the control signal route SR in a route indicated by the broken line between the main signal transmission/reception unit 12h and the authentication unit 121 in the control unit 14h illustrated in FIG. 13. Here, the secure environment between the control unit 14h and the main signal transmission/reception unit 12h is an environment in which at least interaction between the control unit 14h and the main signal transmission/reception unit 12h is not intercepted or data is not falsified.

The authentication unit 121 performs processing similar to the authentication unit 121 described in the first embodiment and the second embodiment. Specifically, setting change control for changing settings related to the control device 20 or the main signal transmission/reception unit 12h is authenticated. Since the function to perform authentication by the authentication unit 121 is similar to that of the first embodiment and the second embodiment, description thereof is omitted.

The main signal transmission/reception unit 12h is a transceiver for the main signal. The main signal transmission/reception unit 12h does not include the authentication unit 121 and the interruption unit 122 as compared with the main signal transmission/reception unit 12 in the first embodiment. The main signal transmission/reception unit 12h transmits and receives the main signal such as an optical signal to and from an opposing device via the communication network. The main signal transmission/reception unit 12h converts the received main signal into an electrical signal and outputs the electrical signal to the switch 13. The main signal transmission/reception unit 12h is usually a replaceable transceiver.

In the eighth embodiment, the control device 20 includes the interruption unit 210. The interruption unit 210 performs processing similar to the interruption unit 210 described in the second embodiment. In such a configuration, the interruption unit 210 included in the control device 20 and the transceiver accommodation device 10h may communicate via a control signal route SR.

Note that the interruption unit 210 may be provided anywhere in a communication network, other than inside the control device 20. In this case, the vicinity of the control device 20 or inside or near an operation system that controls the communication network is favorable. Note that, in the case where the interruption unit 210 is included in a device other than the control device 20, it is assumed that the communication network is configured to be hardly cracked. In a case where the interruption unit 210 interrupts a main signal output from the main signal transmission/reception unit 12h of the transceiver accommodation device 10h in the communication network, the interruption unit 210 is desirably arranged on a flow line of the main signal. In a case where the interruption unit 210 instructs the main signal transmission/reception unit 12h to stop or interrupt power supply, causes the transceiver accommodation device 10h to turn off power supply of the main signal transmission/reception unit 12h, causes the switch 13 to interrupt signal transmission between the main signal transmission/reception unit 12b on the communication network side and the main signal transmission/reception unit 15 on the user device 40 side, or turns off power supply of the transceiver accommodation device 10h itself, the interruption unit 210 is desirably included in the control device 20 as illustrated in FIG. 13.

Processing performed by the communication system 1h in the eighth embodiment is similar to that in the second embodiment except that the authentication unit 121 is included in the control unit 14h instead of in the main signal transmission/reception unit 12h, and thus description thereof is omitted.

According to the communication system 1h configured as described above, the communication of the main signal is interrupted in the case where the connection with the authenticated control device is disconnected or in the case where unauthenticated setting change control has arrived. As a result, it is possible to suppress an influence of an operation against the intention of the telecommunications carrier regarding a business telecommunication facility installed in the user's house.

### Ninth Embodiment

In a ninth embodiment, a configuration using Kubernetes as a container orchestration tool will be generally described, and then a configuration using a specific goldstone will be described.

In containers, an execution process is isolated by a function of Kernel by implementing a name space namespace that executes execution processes only in a separated space by grouping the execution processes and a control group cgroups that restricts hardware resources for the execution process, and a container image is shared in a file system or the like by a copy-on-write (COW) mechanism including a read-only Read Only Layer container image and a Thin R/W layer file of a layer that can be written by the execution processes. In container deletion, only the writable layer is deleted, and thus, in order to save contents after activation, the container is re-imaged as a container image together with a new layer, or a mechanism of separately writing to an external file is configured.

The container image is a combination of a file system that operates an application with a Tape ARchive (TAR) file including a root file system, and metadata of JavaScript Object Notation (JSON) in which settings such as a start command and a port are described. A container execution engine is a library that implements the function of the Kernel as an Application Programming Interface (API), calls a container runtime that generates and executes a container as an internal operation, and realizes container execution. When executing the container, the container execution engine deploys the container image (Filesystem Bundle) and delivers the container image to the container runtime. The runtime includes a Low-level Container Runtime such as runC that creates an isolated environment of the container and directly operates the container, and a High-level Container Runtime such as containerd that deploys the container image and delivers a container execution operation to the Low-level Container Runtime.

Kubernetes calls the High-level Container Runtime according to an API standard of Container Runtime Interface (CRI). Kubernetes is a container orchestration tool that manages containerized workloads and services by performing container placement that is an execution form of an application, scheduling for placing appropriate resources by declaring an expected state, self-healing, and infrastructure abstraction according to business workloads. Kubernetes is described as k8s and its lightweight version is also described as k3s. Two elements constituting a Kubernetes cluster are: an object that is an abstract configuration management file that defines resources such as a container, a network, and a storage operating on the Kubernetes cluster, deployment contents of the container, and an ideal state of policies such as reactivation, upgrade, and connection; and a control plane that is a cluster base that is an implementation and process for realizing a request. An object defined in a YAML Ain't Markup Language (YAML) format is called a manifest.

There are four basic objects related to the control plane: Pod, Service, ReplicaSet, and Deployment. The Pod is an object that manages a unit of deploying containers on a cluster, and is a unit of collecting containers sharing a volume or a network group. The Pod is an object that manages a unit of deploying containers on a cluster, and can activate a plurality of containers therein. The Service is an object for setting access routing for the Pod. The ReplicaSet is an object that manages the number of Pods (the number of replicas) required in a cluster by using a template PodTemplate for creating a Pod. The Deployment is an object that manages release of a new version. Note that Kubernetes does not handle resources on a container basis.

In the control plane, there are two groups of Master Node and Worker Node. The Master Node receives a request from the manifest and schedules a task for an operating container or infrastructure resource. The Worker Node starts or deletes the container in accordance with an instruction from the Master Node, monitors a state of the container activating on its own server, and notifies the Maser Node of the state. The Master Node includes etcd of a distributed storage, kube-apiserver (Kubernetes API) that is an interface for delivering a manifest defining a state as a resource request, kube-sheduler, kube-controller-manager, and the like that receive processing from them. The ideal state refers to a state of a resource stored in the etcd.

The Kubernetes API includes a filter that allows only a user account or a service (service account) having specific authority to refer to or change object information stored in the etcd. A filtering process performs authentication of a connected account, determines authorization of which resources are granted what authorization, and determines user-specific resource limits. A connection source of authentication (Authentication) is roughly divided into a user account of an authentication account for connection of an operator or a process from outside of a cluster and a service account of an authentication account for a process executed in a Pod in a namespace of the cluster. The user account is globally defined in a cluster and is thus unique in the cluster regardless of a namespace, and the service account is managed for each namespace and is unique for each namespace. A service account token is mounted on the Pod as a Secret. In the Kubernetes cluster, authentication of a container registry can be performed by creating the Secret of the registered account. Note that the Secret is not normally a safe object because it is not encrypted, and thus measures together with use of RBAC or the like are required.

An authorization module according to an order of an authorization-mode option controls an operation permitted according to a connection source among accesses for which authentication is permitted. When all the designated modules reject the request, a prohibition response (403) is returned, and when any of the authorization modules approves the request, a procedure proceeds to evaluation of Admission Controller. An evaluation module includes a role-based access (RBAC) of role-based access control that defines RoleBinding that associates an object called Role that defines use authority with a user account or a group, and restricts access. In the RBAC, an object called Role is obtained by combining a resource and verbs of three elements including a subject to be authenticated of a user account or a process, resources such as Pod, Deployments, Services, and Node that are an API resource set available in a cluster, and verbs of a series of CRUD (Create/Read/Update/Delete) operations such as, get, watch, create, and delete that can be executed on the resources, and the Role and the subject are associated with each other by the RoleBinding. The definition may be performed using ClusterRole and ClusterRoleBinding in a case of entire cluster limitation, for example, or by a combination of Role and RoleBinding in the case of restriction in units of namespaces.

Admission Control checks a request content to the API and changes or controls the request. Admission Control is a generic term for Admission Controller that is a plug-in type mounting component that performs each filtering operation. Among these components, a component may be enforced to be a Pod having the functional unit (for example, one of the reception control unit 141, the authentication unit 121, or the interruption unit 122) used in the present application by AlwaysPullImages that performs authentication of image use at the time of activation of the Pod by enforcing an image acquisition policy, or a Token of a predetermined policy may be mounted by ServiceAccount that mounts ServiceAccoutToken for accessing the Kubernetes API. MutatingAdmissionWebhook or ValidatingAdmissionWebhook may be used for flexible restriction.

### Prevention of Modification

Therefore, in a case where the user account is used in the present embodiment, a user having lower authority than the user controlled by the control device 20 on the communication network side is set, and the user having lower authority is kept away from performing control by dividing the namespace of the Pod in which the functional unit (for example, any one of the reception control unit 141, the authentication unit 121, or the interruption unit 122) of the present application is arranged and the namespace of the other Pods, or the namespace of the Pod capable of controlling the settings that should not be controlled by the user and the namespace of the other Pods.

In the case where the service account is used, and in a case where the access from the user can be limited to only a tty (teletypewriter) input or only a COM input corresponding to serial connection, the access is restricted in units of namespaces, and thus the definition may be made by Role or a combination of Role and RoleBinding. Note that, in the present embodiment, an overwrite function itself may not be restricted as long as it is not arranged on the transceiver accommodation device 10. For example, the target may be a user account (login ID), TTY (via CUI), or Management Port (IP address) provided to the user as a Subject. To prevent the network connection, Resource may be kept away from exchanging information of operation of Service, or Pod access in which control related to the settings not to be controlled is collected may be prohibited. Note that Secret of the namespace regarding the setting for restricting access should not be seen from the functional unit or the user of the present application, but deletion change of the functional unit or access to the setting for restricting access may be suppressed by authorization or Access Control.

However, when Secret is seen from the user account provided to the user, the user may access the Secret by falsifying the user account. Therefore, it is desirable to disconnect the main signal in a case where the connection of the communication network with the control device 20 is confirmed, and the connection with the communication network of the control signal transmission/reception unit 11 is released and the connection is disconnected, or in a case where the setting value or the like is checked from the control device 20 of the communication network and connection or change other than the connection from the communication network is detected, and to perform transmission again after inspecting the settings and checked information and confirming the information is normal.

From the viewpoint of preventing change of the setting or the like that should not be accessed from the user by releasing the connection of the control signal transmission/reception unit 11 with the communication network, it is similarly desirable to disconnect the main signal in a case where the connection of the communication network with the control device 20 is confirmed, and the connection with the communication network of the control signal transmission/reception unit 11 is released and the connection is disconnected, or in a case where the setting value or the like is checked from the control device 20 of the communication network and connection or change other than the connection from the communication network is detected, and to perform transmission again after inspecting the settings and checked information and confirming the information is normal, even in the previous embodiments (the first to eighth embodiments).

### Prevention of Deletion of Functional Unit of Present Application

It is desirable that the Pod including the functional unit (for example, any one of the reception control unit 141, the authentication unit 121, or the interruption unit 122) of the present application have a high priority so that the functional unit of the present application is not stopped. Specifically, at the time of new creation or re-creation of the Pod, in a case where NodeName, which is a field of a node to be executed in the definition of the Pod, is not specified and Worker Node is not specified, a suitable Worker Node is selected by the kube-scheduler that always monitors the unspecified Pod, the NodeName is updated, a request for adding a new Pod is notified to the kubelet operating in the target Worker Node, and the Worker Node Pod is activated. On the other hand, when the Pod does not fit on a specific node, the Pod determined to be inappropriate is removed by Predicate of filtering for removing an inappropriate Node. Therefore, the Pod including the functional unit of the present application is desirably weighted with a priority of node such that a request for addition of a new Pod is notified when there is no sufficient Pod for the functional unit to operate, and the Pod is not deleted when the Pod becomes insufficient for the functional unit to operate when the Pod is deleted.

Similarly, in a case where autoscale of the Pod is set, a processing capability is prevented from reduction by an increase or decrease in the number of Pods in scale-out/in in a Horizontal Pod Autoscaler (HPA). In the case of an increase, security is prevented from deterioration. The processing capability (a communication speed and a frequency with a function on the network side, or a speed or a frequency of overwrite or interruption) of processing required in the present application is secured by an increase or decrease in the processing capability of the Pod itself by scale-up or scale-down in a Vertical Pod Autoscaler (VPA). Note that, in the VPA that does not permit the dynamic resource change for the operating Pod, deletes the Pod by an operation or the like via Eviction API, and re-creates the Pod with an appropriate resource by a self-healing function of ReplicaSet or the like, the deletion is not performed in a case where the number of the Pod related to the processing of the present application is less than one. Alternatively, it is desirable that the time during which the processing of the present application in a series of flows is hindered be a predetermined time or less, or the processing be suppressed in a case where the time is not the predetermined time or less. In a case where Pod Disruption Budgets is set, it is desirable that the value of the Pod related to the processing of the present application be sufficiently smaller than allowed duration of an abnormal state allowed in the service.

### Setting Not to be Accessed, TLS Type Used as Certificate with Control Device 20 on Communication Network Side, and Securement of Confidentiality of Authentication Information of Docker Image

A Secret or a ConfigMap object such as a value in an encrypted Key-Value format different for each user account may be registered at the time of activation by a manifest or the like, and read as an environmental variable of the Pod or a volume may be mounted and read so as to be read on the Pod. Here, the Secret or the ConfigMap is a volume for managing the environmental variable or the setting file of the application as an object different from the Pod without including them in the container. The Secret is an object that handle credential information, is appropriately encrypted and stored in the etcd, and is deployed in tmpfs, which is a temporary file system reserved in a memory area on a worker node at the time of use, and does not leave persistent data in the worker node. The ConfigMap manages plain text content as a volume.

In a case of using the above objects and reflecting them in the already activated Pod, Deployment may be updated to switch the Pod, or reread setting or restart may be performed on the process side to reflect them in the process of the container. As a field for reflecting them in the Pod as the environmental variables, “valueFrom.configMapkeyRef”, “envFrom[].configMapRef”, or the like may be used. Instead of the Pod manifest, PodPreset, which is a hook function for adding specific information at the time of Pod creation based on a label selector, may be used to dynamically designate a specific environmental variable at the timing of Pod activation. In the case of using PodPreset, common information can be used without designating all pieces of information for each Pod every time, and it is possible to dynamically assign necessary information and confidential information regardless of a deployment environment.

### Method of Confirming Application Used in Present Application

Cataloging based on a service catalog defined by information Technology infrastructure library (ITIL) or the like, which is a template set of functions, may be utilized, in which various business requirements for an application or a service are defined, and not only configuration information but also a design capable of guaranteeing a deployment process, operation thereof, or quality thereof can be considered. Here, the service catalog is an extended API for using software or a service outside the cluster, which is used by an application executed on the Kubernetes cluster to connect a non-containerized resource such as a managed database or an object storage provided by a cloud provider or the like, and does not mean Kubernetes Service Catalog using the Open Service Broker API standard.

As the requirement definition of the application, an example in which objects such as Deployment, Service, and ConfigMap are individually associated with each other by a label and a selector has been described. However, in order to package a manifest according to a workload to facilitate management, elements necessary for a specific application or service may be determined in advance, objects that can correspond to the elements may be packaged into a template, and package management for rolling back or version management of the application may be performed by applying this package. For example, Helm, which is a package management tool in Kubernetes that can reduce the work of Deployment, Service management, and handling and processing of variables and volumes using ConfigMap, for each application workload, may be used. The Helm is a package obtained by templating and putting together the manifests of Kubernetes, and is a client tool that manages Chart, which is a set of YAMLs. In the case of Helm version 2, the entire package management function includes components of Helm (Client), which is a client tool that calls Chart from a console or a pipeline of CI/CD, and Tiller (Server), which is a service that operates on the Kubernetes cluster and deploys and manages the Chart, and the Helm client interacts with the Tiller via gRPC to send information of the Chart to be deployed and instruct a request for upgrade or uninstallation. The Tiller directs Kubernetes to configure the Chart requested by the Helm client and manages the deployment of resources. In the case of Helm version 3, release information is stored in a custom resource definition (CRD) and operated from the client side without utilizing the Tiller that compares the version deployed on Kubernetes with the release version of the Chart to manage the resources. Using this mechanism, it may be simply confirmed whether the application (for example, the reception control unit 141, the authentication unit 121, or the interruption unit 122) used in the present application is an appropriate version. For example, Release. Time, which is a defined variable of Chart and is the time when release was last updated, or a version field of Release. Revision or Chart.yaml, which is a revision number that increases from 1 every time update is performed, may be used. When an inappropriate version is detected, the Pod having a difference or all the Pods may be restored to an appropriate version by rolling back, or when the version cannot be restored, the version may be interrupted.

Of course, monitoring, detection, and adjustment may be performed using Control Loop, which is a mechanism that realizes the core resources such as the Pod and the Deployment managed by Kubernetes by the resources possessed by Kubernetes and a controller, and includes three states of “Observe” for monitoring a Current State that is a current operating state, “Diff” for comparing a difference between the Current State and a Desired State, and “Act” for adjusting to an appropriate state, to perform adjustment to an appropriate state, or perform interruption in a case where adjustment cannot be performed. Here, the Control loop is managed by a Deployment controller in the case of Deployment. The operational implementation of the application (for example, the reception control unit 141, the authentication unit 121, and the interruption unit 122), which is a custom resource added as a unique resource in the present application, may be monitored, detected, and adjusted from Kubernetes by using “custom resource” and “custom controller”.

Here, the custom resource is a unique data structure obtained by extending the existing Kubernetes API, and a box of extended resources for managing Desired State and Current State of an object stored in the etcd is created, state information unique to the application and a flag necessary for management of a cluster of middleware is stored, and a state that has been managed only on the application side is stored as a resource of Kubernetes, whereby the state of the object is adjusted by the controller using the Control Loop. In this case as well, interruption may be performed in the case where the adjustment cannot be appropriately performed.

Note that, as the custom resource, the API extension may be defined and extended in detail by newly implementing an object as an Aggregated API in the Kubernetes API and registering the object as an API in an Aggregation Layer in the API Aggregation, or may be extended by newly defining a resource without creating a unique API by Customer Resource Definition (CRD). Operator uses the latter API extension by CRD. The custom controller confirms (Diff) the state of a custom resource or a core resource, and adjusts (Act) the object managed in a case where there is an Event to be updated in Desired State of the resource.

Next, a configuration using goldstone as software incorporated in a control unit 14 of a transceiver accommodation device 10 will be described. In the above-described embodiments, the transceiver accommodation devices 10b, 10c, 10d, and 10h (for example, the second embodiment, the third embodiment, the fourth embodiment, and the eighth embodiment) in which the control unit 14 does not include the interruption unit 122, and the transceiver accommodation devices 10e and 10g (for example, the fifth embodiment and the seventh embodiment) in which the control unit 14 includes the interruption unit 122 have been described. In the description of the ninth embodiment, a case where the control unit 14 includes the interruption unit 122 and a case where the control unit 14 does not include the interruption unit 122 will be separately described.

### Case Where Control Unit 14 Does Not Include Interruption Unit 122

As a configuration in a case where the control unit 14 does not include an interruption unit 122, a transceiver accommodation device 10b in the second embodiment will be described as an example. Note that basic processing is similar in the transceiver accommodation devices 10c, 10d, and 10h in the third embodiment, the fourth embodiment, and the eighth embodiment. As software that operates on the control unit 14 of the transceiver accommodation device 10b in the second embodiment, a set of a network OS, goldstone, setting functions, and the like of a white box switch is installed in the white box switch. A reception control unit 141, which is a setting function, may be an application on an OS different from the goldstone or an application on the goldstone.

In a case where the reception control unit 141 is an application on the goldstone, the reception control unit 141 may be an application not included in a normal goldstone, and may be an application on containers on different Pods, may be an application on another container on the same Pod, may be an application on the same container on the same Pod, or may be an integrated application. A part of the application of an existing goldstone may be modified.

For example, as a configuration in which the number of changes of the transceiver accommodation device 10b is small, the reception control unit 141 is a North Management Interface including a Command Line Interface (CLI), netfonf, a Simple Network Management Protocol (SNMP), restconf, and the like in advance, or Sysrepo in which they write values. Note that the configuration illustrated in FIG. 9 of Non Patent Literature 1 corresponds to South TAI of South Management Layer. The North Management Interface, Sysrepo, or the South TAI may be modified to have a function to receive only a value via a predetermined route from the communication network and overwrite the related setting with the value, or may be separately provided in parallel with the North Management Interface or the South TAI.
An application that uses Sysrepo (Sysrepo is a YANG-based data store for UNIX (registered trademark)/Linux (registered trademark) systems that stores an application configuration described in the YANG format) may be restricted with NETCONF (Sysrepo can manage an application using Sysrepo integrated with a Netopeer2 NETCONF server with NETCONF.)
Since Sysrepo does not have a master process that can enforce complex access control, it relies on standard file system permission and is used with the following in mind. A correct authority and an owner are always set for all of YANG modules to be installed to ensure that the confidential data is not accessible from unauthorized processes. Utility Sysrepoctl is used for both display (—list) and change (—change<module>) of all authorities, in addition to this function that can be used in the API. Sysrepo is completely suspended by being written to a shared file that needs to be accessible from all processes linked to Sysrepo. In some reverse engineering, two cmake variables Sysrepo_umask and Sysrepogroup are adjusted so that when data is being communicated in the shared file, the data is not accessed by a denormalization process. Generally, a new system group is created and set in Sysrepo_group, and then Sysrepojmask is set to 00007 to prohibit all external accesses.
   In a case where all user accounts running the Sysrepo process belong to this group, the Sysrepo files and confidential information are made not accessible from other user accounts.

### Case Where Control Unit 14 Includes Interruption Unit 122

As a configuration in a case where the control unit 14 includes the interruption unit 122, the transceiver accommodation device 10e in the fifth embodiment will be described as an example. Note that basic processing is similar in the transceiver accommodation device 10g in the seventh embodiment. As software that operates on the control unit 14e of the transceiver accommodation device 10e in the fifth embodiment, a NOS, goldstone, setting functions, an interruption function, and the like of a white box switch are installed in the white box switch. A reception control unit 141 and an authentication unit 121, which are setting functions, and the interruption unit 122 as an interruption function may be an application on an OS different from the goldstone or an application on the goldstone.

In a case where the reception control unit 141, the authentication unit 121, and the interruption unit 122 are an application on the goldstone, the reception control unit 141, the authentication unit 121, and the interruption unit 122 may be an application not included in a normal goldstone, and may be an application on containers on different Pods, may be an application on another container on the same Pod, may be an application on the same container on the same Pod, or may be an integrated application. A part of the application of an existing goldstone may be modified.

For example, as a configuration in which the number of changes of the transceiver accommodation device 10e is small, the reception control unit 141 is a North Management Interface including CLI, netfonf, SNMP, restconf, and the like in advance, or Sysrepo in which they write values. The authentication unit 121 and the interruption unit 122 are TAI or tai shell. Note that the configuration illustrated in FIG. 9 of Non Patent Literature 1 corresponds to South TAI of South Management Layer. The North Management Interface, Sysrepo, or the South TAI may be modified to have a function to receive only a value via a predetermined route from the communication network and overwrite the related setting with the value, or may be separately provided in parallel with the North Management Interface or the South TAI.

It is desirable to transmit a Dying GASP equivalent to the control device 20 side, but estimation may be performed on the control device 20 side by checking block equivalent to Keep alive or Health check.
An application that uses Sysrepo (Sysrepo is a YANG-based data store for UNIX (registered trademark)/Linux (registered trademark) systems that stores an application configuration described in the YANG format) may be restricted with NETCONF (Sysrepo can manage an application using Sysrepo integrated with a Netopeer2 NETCONF server with NETCONF.)
Since Sysrepo does not have a master process that can enforce complex access control, it relies on standard file system permission and is used with the following in mind. A correct authority and an owner are always set for all of YANG modules to be installed to ensure that the confidential data is not accessible from unauthorized processes. Utility Sysrepoctl is used for both display (—list) and change (—change<module>) of all authorities, in addition to this function that can be used in the API. Sysrepo is completely suspended by being written to a shared file that needs to be accessible from all processes linked to Sysrepo. In some reverse engineering, two cmake variables Sysrepo_umask and Sysrepogroup are adjusted so that when data is being communicated in the shared file, the data is not accessed by a denormalization process. Generally, a new system group is created and set in Sysrepo_group, and then Sysrepojmask is set to 00007 to prohibit all external accesses. In a case where all user accounts running the Sysrepo process belong to this group, the Sysrepo files and confidential information are made not accessible from other user accounts.

### Modification 1

In the ninth embodiment, the transceiver accommodation device 10 may be configured to restrict addition or duplication of a new Namespace, Node, or container related to deletion or modification of the functional unit (for example, the reception control unit 141, the authentication unit 121, and the interruption unit 122) added in each embodiment or bypassing processing of the functional unit added in each embodiment by Kubanetes or the like. In this case, a container in which the authentication unit 121 on the transceiver accommodation device 10 is disposed, a Node corresponding to the container, or the like may not be in a state of being accessible from the control device 20, or may not be in a state of being interrupted in a case where the authentication unit 121 performs interruption.

### Second Modification

In the ninth embodiment, the transceiver accommodation device 10 may be configured to be activated as follows. The transceiver accommodation device may be activated only in a form in which the transceiver accommodation device is not re-activated even if the user-side control terminal 30 logs in to the transceiver accommodation device at the time of re-authentication and re-activation from the time of activation, such as interruption at the time of activation or stop or connection to a control device (APNC) of the all-photonics network, and the transceiver accommodation device accepts only control from the control device (gateway) side (re-authentication from interruption at the time of activation or stop, or from connection or activation of all-photonics network control device).

### Third Modification

In the ninth embodiment, the transceiver accommodation device 10 may be configured to be automatically started as follows. In the automatic startup, for example, in a normal startup sequence, a goldstone startup screen→in Kubanetes immediately after startup→tai shell stop (tai.sh stop)→tai shell startup (tai.sh start)→south-tai restart (k rollout restart ds/south-tai)→tai shell startup (k exec-it deploy/tai—taish)→enters each PIU (plug-in unit) from the tai shell (module/dev/piul, here an example of piul)→if the main signal transmission/reception unit 12 is activated (set admin-status up), it is also automatically started.

### Fourth Modification

In the transceiver accommodation device 10 in the ninth embodiment, an ID of an authority lower than an administrator authority may be created, and only the ID of the lower authority may be accessible by the user. In addition, a file of software or settings related to deletion/modification of the functional units added in each embodiment is set to be unreadable, unwritable, unexecutable, or only readable with the ID of the lower authority. In the case of a file, a mode is ---(0) or r--(4) (read/write/execute).

### Fifth Modification

In the ninth embodiment, the transceiver accommodation device 10 may be configured to perform the following access restriction related to the deletion/modification of the functional units added in each embodiment.

### Access Restriction Related to Deletion/Modification of Predetermined Functional Units

An internet protocol (IP) address may be made unsearchable. Address resolution or advertisement of the IP address between the container in which the setting value or the like is arranged and the functional unit itself or the like in a routing table of Kubernetes and the operating system is suppressed. Further, by setting the IP address to a value that is difficult to estimate, access is suppressed.
A network access control list may restrict an IP address required for cluster management or may restrict access to a related node, for access to an API server (Kubernetes control plane).
Network traffic between services related to TAI may be encrypted using TLS mutual transport layer security (mTLS) or the like.
In Kubernetes, a security policy that enforces the authority of a Pod or a container or an Open Policy Agent Gatekeeper (OPA gatekeeper) may be used.
Although there is no access restriction by default in Kubernetes, by using the network policy, an “ingress rule” may be described for the Pod, and the “ingress rule” may be used to perform access control in units of “Pod (IP address)” or “TCP/UDP port”.

The transceiver accommodation device or the control device executes a sequence of restricting addition and duplication of a new name space, node, or container that bypasses processing of a predetermined functional unit, by using Kubernetes.

It is desirable that the transceiver accommodation device transmits a signal corresponding to “Dying GASP” to a communication network 2 (gateway) side, but the control device (gateway) may estimate (determine) communication interruption on the basis of “Keep alive” or “Health check”.

The transceiver accommodation device may be activated only in a form in which the transceiver accommodation device is not re-activated even if the user-side control terminal 30 logs in to the transceiver accommodation device at the time of re-activation, such as interruption at the time of activation or stop, confirmation of a software configuration at the time of activation, or connection to the control device (APNC) of the all-photonics network, and the transceiver accommodation device accepts only control from the control device (gateway) side (interruption at the time of activation or stop, confirmation of the software configuration at the time of activation, automatic activation at the time of activation, and connection to the control device of all-photonics network).

In the automatic startup of the transceiver accommodation device, for example, by using open source software (Transponder Abstraction Interface (TAI)) that enables separation of hardware and software in an optical transmission network between data centers, in a case where a normal startup sequence is a sequence of “Goldstone startup screen”→“in Kubernetes immediately after startup”→“tai.shell stop (tai.sh stop)”→“tai.shell startup (tai.sh start)”→“south-tai restart (k rollout restart ds/south-tai)”→“tai shell startup (k exec-it deploy/tai—taish)”→“From the tai shell, enter each PIU (plug-in unit) (module/dev/piul, here an example of piul)”→“the transceiver is activated (set admin-status up)”, they are also automatically started.
An ID of an authority lower than the administrator authority is created, and only the ID of the lower authority is made accessible to the user. In addition, a file of software or settings that is not changeable by the user is set to be unreadable, unwritable, unexecutable, or only readable with the ID of the lower authority. In the case of a file, a mode is “---(0)” or “r--(4)” (read/write/execute).

### Access Restriction

An internet protocol (IP) address may be made unsearchable. Address resolution or advertisement of the IP address between the container in which the setting value or the like is arranged and the functional unit itself or the like in a routing table of Kubernetes and the operating system is suppressed. Further, by setting the IP address to a value that is difficult to estimate, access is suppressed.
A network access control list may restrict an IP address required for cluster management or may restrict access to a related node, for access to an API server (Kubernetes control plane).
Network traffic between services related to TAI may be encrypted using TLS mutual transport layer security (mTLS) or the like.
In Kubernetes, a security policy that enforces the authority of a Pod or a container or an Open Policy Agent Gatekeeper (OPA gatekeeper) may be used.
Although there is no access restriction by default in Kubernetes, by using the network policy, an “ingress rule” may be described for the Pod, and the “ingress rule” may be used to perform access control in units of “Pod (IP address)” or “TCP/UDP port”.
An application that uses a system repository configuration “Sysrepo” may be restricted with “NETCONF”. “Sysrepo” is a Yet Another Next Generation (YANG)-based data store for “UNIX (registered trademark)/Linux (registered trademark) system”, and stores an application configuration described in a YANG format. “Sysrepo” can manage an application using “Sysrepo” integrated in the “Netopeer2 NETCONF server” with “NETCONF”.
Since “Sysrepo” does not have a master process that can enforce complex access control, it relies on standard file system permission and is used with the following in mind.

A correct authority and an owner are always set for all of YANG modules to be installed to ensure that the confidential data is not accessible from unauthorized processes. In utility “sysrepoctl” (control of the system repository configuration), both display (—list) and change (—change<module>) of all authorities are used in addition to this function that can be used in an application programming interface (API).

“Sysrepo” is completely suspended by being written to a shared file that needs to be accessible from all processes linked to “Sysrepo”. In some reverse engineering, two cmake variables (sysrepo_umask and sysrepo_group) are adjusted so that when data is being communicated in the shared file, the data is not accessed by a denormalization process.

Generally, a new system group is created and set in “sysrepo_group”, and then “sysrepo_jmask” is set to 00007 to prohibit all external accesses. By setting “sysrepo_umask” to “00007”, all accesses from the outside may be prohibited. In a case where all user accounts running the “Sysrepo” process belong to this group, the “Sysrepo” files and confidential information may be made not accessible from other user accounts.

The value held or generated in the transceiver accommodation device may be transmitted to the communication network 2 without exchanging login information.

As described above, it is possible to suppress the influence of the operation against the intention of the telecommunications carrier on service provision by using the device software (Goldstone) that is implemented in the control unit 14 by software in advance.

### Hardware Configuration

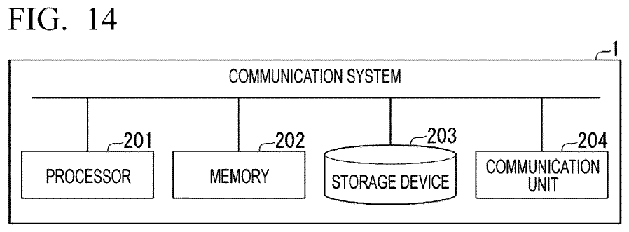

FIG. 14 is a diagram illustrating a hardware configuration example of the communication system 1 in each embodiment. The communication system 1 illustrated in FIG. 14 corresponds to each of the communication system 1a of the first embodiment, the communication system 1b of the second embodiment, the communication system 1c of the third embodiment, the communication system 1d of the fourth embodiment, the communication system 1e of the fifth embodiment, the communication system 1f of the sixth embodiment, the communication system 1g of the seventh embodiment, and the communication system 1h of the eighth embodiment. The communication system 1 is implemented as software by a processor 201 such as a CPU executing a program stored in a storage device 203 including a nonvolatile recording medium (non-transitory recording medium) and a memory 202. The program may be recorded in a computer-readable recording medium. The computer-readable recording medium is, for example, a non-transitory storage medium including a portable medium such as a flexible disk, a magneto-optical disc, a ROM, or a CD-ROM and a storage device such as a hard disk built in a computer system. A communication unit 204 executes communication processing.

The communication system 1 may be implemented by using hardware including an electronic circuit (or circuitry) using, for example, a large scale integrated (LSI) circuit, an application specific integrated circuit (ASIC), a programmable logic device (PLD), or a field programmable gate array (FPGA).

Although the embodiments of the present invention have been described in detail with reference to the drawings, specific configurations are not limited to the embodiments, and include design and the like within the scope of the present invention without departing from the gist of the present invention.

### INDUSTRIAL APPLICABILITY

The present invention can be applied to an optical communication system such as an all-photonics network (APN).

### REFERENCE SIGNS LIST

1a, 1b, 1c, 1d, 1e, 1f, 1g, 1h Communication system
10a, 10b, 10c, 10d, 10e, 10f, 10g, 10h Transceiver accommodation device
20 Control device
30 User-side control terminal
11 Control signal transmission/reception unit
12, 12b, 12c, 12d, 12e, 12f, 12g, 12h Main signal transmission/reception unit
121 Authentication unit
122, 210 Interruption unit
13 Switch
14 Control unit
141, 141d, 141f, 141g, 141h Reception control unit

1. A communication system comprising:
an authorizer configured to authenticate one of a control device arranged in a communication network or setting control for setting related to a main signal transceiver, and performs the setting related to the main signal transceiver according to an authentication result.

2. The communication system according to claim 1, wherein
communication of a main signal with the control device is in an interrupted state, and
an interrupter configured to release at least interruption of the communication of a main signal in a case where there has been access from the control device authenticated by the authorizer, in a case where conduction has been controlled from the authenticated control device, in a case where connection with the authenticated control device has been performed, or in a case where authenticated setting change control has arrived is further included.

3. The communication system according to claim 1, further comprising:
a reception controller configured to construct a secure communication route between the main signal transceiver and a control device arranged in the communication network before communication conduction of a main signal between the communication network and the main signal transceiver is permitted.

4. The communication system according to claim 1, wherein
the authorizer is included in the main signal transceiver or in an accommodation device installed in a user's house including the main signal transceiver.

5. The communication system according to claim 2, wherein
the authorizer and the interrupter are included in the main signal transceiver or in an accommodation device installed in a user's house including the main signal transceiver.

6. The communication system according to claim 2, wherein
the authorizer is included in an accommodation device installed in a user's house including the main signal transceiver, and the interrupter is arranged in the communication network,
the authorizer is arranged in the communication network, and the interrupter is included in the main signal transceiver,
the authorizer is included in the main signal transceiver, and the interrupter is arranged in the communication network,
the authorizer is included in the main signal transceiver, and the interrupter is included in an accommodation device installed in a user's house including the main signal transceiver, or
the authorizer is included in an accommodation device installed in a user's house including the main signal transceiver, and the interrupter is included in the main signal transceiver.

7. A setting method executed by a communication system, the setting method comprising:
an authentication step of authenticating a control device arranged in a communication network or setting control for setting related to a main signal transceiver, and performing the setting related to a main signal transceiver according to an authentication result.

8. A non-transitory storage medium that stores a program for making a computer perform processes, the processes comprising:
authenticating a control device arranged in a communication network or setting control for setting related to a main signal transceiver, and performing the setting related to a main signal transceiver according to an authentication result.
